(19) United States
(12) Patent Application Publication
(10) Pub. No.: US 2026/0348404 A1
(43) Pub. Date: Nov. 5, 2026

(54) HYDRAULIC VALVE SYSTEM WITH FLOAT MODE CONTROL

(71) Applicant: Austin J. Karst, Montrose, MN (US)

(72) Inventor: Austin J. Karst, Montrose, MN (US)

(21) Appl. No.: 19/423,029

(22) Filed: Dec. 17, 2025

Related U.S. Application Data
(63) Continuation-in-part of application No. 19/410,059, filed on Dec. 5, 2025.
(60) Provisional application No. 63/798,611, filed on May 2, 2025.
(60) Provisional application No. 63/804,068, filed on May 12, 2025.

(51) Int. Cl. F15B 13/04; F15B 1/26; F15B 13/02; F15B 13/044; F15B 15/26; F15B 20/00

(52) U.S. Cl. CPC F15B 13/0401; F15B 1/26; F15B 13/024; F15B 13/044; F15B 15/26; F15B 20/00; F15B 2015/267; F15B 2211/7741

(57) ABSTRACT

A hydraulic control system and method enable controlled float functionality in a hydraulic actuator. The system includes a control valve operable in a plurality of states, including a float state, and configured to selectively establish fluid communication between working connections and tank via float passages and bypass connections. An electronically controlled locking device mechanically prevents unintentional transitions into the float state based on one or more safety conditions, including operator presence, vehicle speed, or control logic. The system includes an electronically controlled blocking valve disposed in a float passage, selectively permitting fluid flow based on float state activation and safety conditions. Sensors and control logic enable monitoring of control element position, command and feedback current for fault detection, and logging of operational states for diagnostic purposes. A flanged manifold is integrated to house load-holding valves, float passage restrictions, and interface ports for simplified system integration.

### CROSS-REFERENCE TO RELATED APPLICATIONS

This application is a Utility Patent application claiming priority to U.S. patent application Ser. No. 19/410,059, filed on Dec. 5, 2025, U.S. Provisional Patent Application Ser. No. 63/804,058, filed on May 12, 2025, and U.S. Provisional Patent Application Ser. No. 63/798,611, filed on May 2, 2025, which are incorporated by reference herein in their entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The present disclosure relates to hydraulic control systems, and more particularly to hydraulic valves and methods for controlling hydraulic actuators in machines that enable selective float mode operation while maintaining load-holding functionality.

### 2) Description of Related Art

Hydraulic control systems are widely used in various types of working machines, including skid steer loaders, compact wheel loaders, excavators, and other construction equipment. These systems typically employ hydraulic cylinders to actuate mechanical components such as booms, buckets, and auxiliary attachments. The hydraulic cylinders are controlled by valve assemblies that direct pressurized fluid to extend or retract the cylinders as desired by the operator.

In many hydraulic systems, control valves are arranged in a series configuration, commonly referred to as an open-center valve arrangement. In such systems, hydraulic fluid flows through a central passage when the valve spools are in their neutral positions, allowing fluid to be delivered sequentially to downstream valve sections. When a valve spool is actuated, pressurized fluid is directed to one side of a hydraulic cylinder while return flow from the opposite side can be routed to downstream functions, enabling simultaneous operation of multiple actuators.

One function that is particularly valuable in working machines is float mode operation. Float mode allows a hydraulic actuator, such as a boom cylinder, to move freely in response to external forces rather than being held in a fixed position by hydraulic pressure. This functionality enables implements to passively follow ground contours during operations such as grading, snow removal, or back dragging, where maintaining consistent contact with uneven terrain is beneficial for achieving uniform surface finishes.

However, implementing float functionality in hydraulic systems presents challenges, particularly when load-holding valves are incorporated into the circuit. Load-holding valves, such as pilot-operated check valves and counterbalance valves, are commonly used to prevent unintended actuator movement and provide safety functionality by holding loads in position. These valves typically require a minimum pilot pressure to open and allow reverse flow. During float mode operation, system pressure is intentionally reduced or routed to tank, resulting in insufficient pilot pressure to actuate the load-holding valves, thereby preventing the desired float functionality.

Various approaches have been developed to address this challenge, including the use of bypass valves, dedicated tank passages, and additional hydraulic components such as charge pumps to generate the pilot pressure needed to enable float mode. While these solutions can be effective, they often increase system complexity, cost, and space requirements. Additionally, some existing float systems may lack adequate safety features to prevent unintended activation of float mode, which could result in uncontrolled movement of heavy implements or boom assemblies.

There remains a need for improved hydraulic control systems that can provide reliable float functionality while maintaining load-holding capabilities, without significantly increasing system complexity or compromising operational safety.

### BRIEF SUMMARY OF THE INVENTION

According to an aspect of the present disclosure, a hydraulic system for a machine is provided. The hydraulic system comprises a tank operable to store a hydraulic fluid and a first pump operable to output a flow of hydraulic fluid. The hydraulic system further comprises a first hydraulic actuator to be operated by the hydraulic fluid having a first fluid port for supplying the hydraulic fluid to move the actuator in a first direction, and a second fluid port for supplying the hydraulic fluid to move the actuator in a second direction. The hydraulic system also comprises a second hydraulic actuator to be operated by the hydraulic fluid having a third fluid port for supplying the hydraulic fluid to move the actuator in a first direction, and a fourth fluid port for supplying the hydraulic fluid to move the actuator in a second direction. The hydraulic system includes a first control valve controllable among a plurality of states including at least a first state and a second state to control the first hydraulic actuator, and a second control valve disposed downstream of the first control valve and controllable among a plurality of states including at least a first state and a second state to control the second hydraulic actuator. The first control valve comprises a first free flow connection fluidly connectable to a second free flow connection, a supply connection configured to receive pressurized fluid from a pump and being selectively fluidly connectable to one or more working connections depending on a state of the first control valve, a first working connection and a second working connection, each fluidly connected to a respective first fluid port and second fluid port via a corresponding first working passage and second working passage, at least one primary bypass connection fluidly connected to at least one primary bypass passage, wherein the primary bypass passage is fluidly connected to tank, and at least one float connection fluidly connected to at least one float passage. The float passage is configured to be fluidly connected to at least one working passage, the connection being located downstream of a load holding valve disposed in-line with the working passage or to be fluidly connected to at least one dedicated float port. Each of the free flow connections, the supply connection, the working connections, the primary bypass connection, and the float connection is positioned proximate to a control element within the first control valve at one or more locations thereon, and is selectively fluidly connectable to one or more of the others depending on a state of the first control valve.

According to other aspects of the present disclosure, the hydraulic system may include one or more of the following features. The first control valve may be configured, in a first state, to allow fluid communication between the first free flow connection and the second free flow connection, such that fluid output from the pump flows through the first control valve to a third free flow connection of a second control valve, and either fluidly connect at least one of the working connections to the primary bypass connection or fluidly block at least one of the working connections from the primary bypass connection. The first control valve may be further configured to block fluid communication between the float connection and either the primary bypass connection or a dedicated float bypass connection when the control element is not in a float state. The first control valve may be configured, in a second state, to fluidly connect the supply connection to at least one of the working connections to direct pressurized fluid for actuating a function of an actuator, and fluidly isolate the float connection from at least one of a primary bypass connection or a dedicated float bypass connection, thereby ensuring that the actuator operates under controlled pressure rather than gravity-induced float movement. The first control valve may be further configured, in a third state, to fluidly connect at least one of the working connections to a float bypass connection, thereby permitting flow from the actuator to tank via a float passage, fluidly isolate the supply connection to prevent active pressure delivery to the working connections, and fluidly connect the first free flow connection to the second free flow connection, thereby allowing fluid to pass through the first control valve to a third free flow connection of a second control valve while in the third state. The first control valve may be further configured to include at least one check valve disposed within the control element and configured, in the first and second states, to prevent fluid flow from the float connection to at least one of a primary bypass connection or a float bypass connection, and wherein the check valve is further configured, in the third state, to permit fluid communication between the float connection and at least one of the primary bypass connections or the float bypass connection in both directions. A restriction may be disposed within the first control valve between at least one of the float connections and at least one of the bypass connections, the bypass connections comprising a primary bypass connection or a float bypass connection. The restriction may be formed within a control element of the first control valve and may be configured to restrict fluid flow between at least one of the float connections and at least one of the bypass connections. The first control valve may be mechanically operable between a plurality of states, and an electronically controlled locking device may be configured to mechanically prevent the first control valve from transitioning into the third state, thereby preventing the float connection from being fluidly connected to either the primary bypass connection or the float bypass connection. The electronically controlled locking device may be actuated in response to one or more control signals corresponding to operating conditions of the machine, the control signals comprising at least one of an operator presence signal, a vehicle speed signal, a machine orientation signal, or a control system logic condition. The electronically controlled locking device may comprise an electromechanical actuator configured to selectively engage or disengage a mechanical lock that restricts movement of the control element into the third state, and may further comprise a manual override mechanism configured to enable operator-initiated disengagement of the mechanical lock independently of the control signal. At least one restriction may be disposed in at least one of the float passages or the float bypass passages. The float passage may be configured to be fluidly connected to at least one dedicated float port, the dedicated float port, and the first and second fluid ports, may be in fluid communication with a flanged manifold, the flanged manifold may comprise corresponding float passages and working passages, and may include at least one load holding valve disposed within at least one of the working passages, the working connections of the first control valve may be fluidly connected to the working passages of the flanged manifold, the float passage internal to the flanged manifold may be fluidly connected downstream of the in-line load holding valve, and the flanged manifold may include final working ports configured to be fluidly connected to an actuator. At least one restriction may be disposed in at least one of the float passages, the float passages being located in either the flanged manifold or the first control valve. At least one electronically controlled blocking valve may be disposed in at least one of the float passages, the float passages being located in either the flanged manifold or the first control valve, wherein the electronically controlled blocking valve may be configured to selectively block or permit fluid flow from the flanged manifold to the first control valve based on a control state. A position sensor may be disposed within the first control valve and may be configured to generate an electrical signal indicative of a position of a control element and wherein the electrical signal may be transmitted to a controller, thereby enabling the controller to determine an operational state of the first control valve.

According to another aspect of the present disclosure, a method for controlling float functionality in a hydraulic system comprising a first control valve operable in a plurality of states including a float state is provided. The method comprises receiving a control input to transition the first control valve toward a float state, determining whether one or more safety conditions are satisfied, the safety conditions comprising at least one of an operator presence signal, a machine orientation condition, a vehicle speed threshold, or a system control logic condition, preventing the first control valve from transitioning into the float state when the one or more safety conditions are not satisfied, by engaging an electronically controlled locking device configured to mechanically restrict movement of a control element, allowing the first control valve to transition into the float state only when the one or more safety conditions are satisfied, and permitting fluid communication between at least one working connection and a tank via a float passage, the float passage being fluidly connected to at least one float connection and at least one of a primary bypass connection or a float bypass connection, only when the first control valve is in the float state.

According to other aspects of the present disclosure, the method may include one or more of the following features. The method may further comprise overriding the electronically controlled locking device by actuating a manual override mechanism wherein the manual override mechanism may be configured to mechanically disengage the locking device independently of the one or more safety conditions, thereby allowing the first control valve to transition into the float state. The method may further comprise controlling an electronically controlled blocking valve disposed in a float passage, wherein the blocking valve may be configured to prevent fluid communication between the float passage and the first control valve unless the one or more safety conditions are satisfied, and wherein the blocking valve may be actuated to permit fluid communication only when the first control valve is in the float state and the one or more safety conditions are satisfied. The method may further comprise recording or transmitting a control state log associated with the first control valve, wherein the control state log may include at least one of an attempted transition into the float state, a status of the electronically controlled locking device, an activation of the manual override mechanism, or a state of the electronically controlled blocking valve. The method may further comprise supplying a command current to the first control valve to initiate a transition into the float state, measuring or interpreting a current feedback signal from at least one of a high-side driver or a low-side driver associated with the first control valve, comparing the command current to the current feedback signal to detect a fault condition associated with the attempted transition into the float state, and in response to detecting the fault condition, preventing the first control valve from transitioning into the float state and initiating one or more safety precautions.

One aspect is directed to a hydraulic system for a machine. The hydraulic system includes a tank operable to store a hydraulic fluid, a first pump operable to output a flow of hydraulic fluid, and a first hydraulic actuator to be operated by the hydraulic fluid having a first fluid port for supplying the hydraulic fluid to move the actuator in a first direction, and a second fluid port for supplying the hydraulic fluid to move the actuator in a second direction. The hydraulic system includes a second hydraulic actuator to be operated by the hydraulic fluid having a third fluid port for supplying the hydraulic fluid to move the actuator in a first direction, and a fourth fluid port for supplying the hydraulic fluid to move the actuator in a second direction. The hydraulic system includes a first control valve controllable among a plurality of states including at least a first state and a second state to control the first hydraulic actuator. The system includes a second control valve disposed downstream of the first control valve and controllable among a plurality of states including at least a first state and a second state to control the second hydraulic actuator and a first control valve. The first control valve includes a first free flow connection fluidly connectable to a second free flow connection, a supply connection configured to receive pressurized fluid from a pump and being selectively fluidly connectable to one or more working connections depending on a state of the first control valve, a first working connection and a second working connection, each fluidly connected to a respective first fluid port and second fluid port via a corresponding first working passage and second working passage, at least one primary bypass connection fluidly connected to at least one primary bypass passage, wherein the primary bypass passage is fluidly connected to tank, and at least one float connection fluidly connected to at least one float passage. The float passage may be configured to be fluidly connected to at least one working passage, the connection being located downstream of a load holding valve disposed in-line with the working passage or to be fluidly connected to at least one dedicated float port. Each of the free flow connections, the supply connection, the working connections, the primary bypass connection, and the float connection may be positioned proximate to a control element within the first control valve at one or more locations thereon, and is selectively fluidly connectable to one or more of the others depending on a state of the first control valve. The first control valve may be configured, in a first state, to allow fluid communication between the first free flow connection and the second free flow connection, such that fluid output from the pump flows through the first control valve to a third free flow connection of a second control valve, and either fluidly connect at least one of the working connections to the primary bypass connection or fluidly block at least one of the working connections from the primary bypass connection. The first control valve may be further configured to block fluid communication between the float connection and either the primary bypass connection or a dedicated float bypass connection when the control element is not in a float state. The first control valve may be configured, in a second state, to fluidly connect the supply connection to at least one of the working connections to direct pressurized fluid for actuating a function of an actuator and fluidly isolate the float connection from at least one of a primary bypass connection or a dedicated float bypass connection, thereby ensuring that the actuator operates under controlled pressure rather than gravity-induced float movement. The first control valve may be further configured, in a third state, to fluidly connect at least one of the working connections to a float bypass connection, thereby permitting flow from the actuator to tank via a float passage, to fluidly isolate the supply connection to prevent active pressure delivery to the working connections, and fluidly connect the first free flow connection to the second free flow connection, thereby allowing fluid to pass through the first control valve to a third free flow connection of a second control valve while in the third state. The first control valve may be further configured to include at least one check valve disposed within the control element and configured, in the first and second states, to prevent fluid flow from the float connection to at least one of a primary bypass connection or a float bypass connection. The check valve may be further configured, in the third state, to permit fluid communication between the float connection and at least one of the primary bypass connections or the float bypass connection in both directions. A restriction may be disposed within the first control valve between at least one of the float connections and at least one of the bypass connections, the bypass connections comprising a primary bypass connection or a float bypass connection. The restriction is formed within a control element of the first control valve and is configured to restrict fluid flow between at least one of the float connections and at least one of the bypass connections. The first control valve may be mechanically operable between a plurality of states, and an electronically controlled locking device is configured to mechanically prevent the first control valve from transitioning into the third state, thereby preventing the float connection from being fluidly connected to either the primary bypass connection or the float bypass connection. The electronically controlled locking device may be actuated in response to one or more control signals corresponding to operating conditions of the machine, the control signals comprising at least one of: an operator presence signal, a vehicle speed signal, a machine orientation signal, or a control system logic condition. The electronically controlled locking device may include an electromechanical actuator configured to selectively engage or disengage a mechanical lock that restricts movement of the control element into the third state; and further comprises a manual override mechanism configured to enable operator-initiated disengagement of the mechanical lock independently of the control signal. At least one restriction is disposed in at least one of the float passages or the float bypass passages. The float passage may be configured to be fluidly connected to at least one dedicated float port. The dedicated float port, and the first and second fluid ports, are in fluid communication with a flanged manifold. The flanged manifold includes corresponding float passages and working passages, and includes at least one load holding valve disposed within at least one of the working passages. The working connections of the first control valve may be fluidly connected to the working passages of the flanged manifold. The float passage internal to the flanged manifold may be fluidly connected downstream of the in-line load holding valve. The flanged manifold may include final working ports configured to be fluidly connected to an actuator. At least one restriction is disposed in at least one of the float passages, the float passages being located in either the flanged manifold or the first control valve. At least one electronically controlled blocking valve is disposed in at least one of the float passages, the float passages being located in either the flanged manifold or the first control valve. The electronically controlled blocking valve is configured to selectively block or permit fluid flow from the flanged manifold to the first control valve based on a control state. A position sensor is disposed within the first control valve and is configured to generate an electrical signal indicative of a position of a control element and wherein the electrical signal is transmitted to a controller, thereby enabling the controller to determine an operational state of the first control valve.

Another aspect is directed to a method for controlling float functionality in a hydraulic system. The method includes a first control valve operable in a plurality of states including a float state. The method includes receiving a control input to transition the first control valve toward a float state, determining whether one or more safety conditions are satisfied, the safety conditions comprising at least one of: an operator presence signal, a machine orientation condition, a vehicle speed threshold, or a system control logic condition and preventing the first control valve from transitioning into the float state when the one or more safety conditions are not satisfied, by engaging an electronically controlled locking device configured to mechanically restrict movement of a control element. The method includes allowing the first control valve to transition into the float state only when the one or more safety conditions are satisfied and permitting fluid communication between at least one working connection and a tank via a float passage, the float passage being fluidly connected to at least one float connection and at least one of a primary bypass connection or a float bypass connection, only when the first control valve is in the float state. The method may include overriding the electronically controlled locking device by actuating a manual override mechanism wherein the manual override mechanism is configured to mechanically disengage the locking device independently of the one or more safety conditions, thereby allowing the first control valve to transition into the float state. The method may include controlling an electronically controlled blocking valve disposed in a float passage. The blocking valve may be configured to prevent fluid communication between the float passage and the first control valve unless the one or more safety conditions are satisfied. The blocking valve may be actuated to permit fluid communication only when the first control valve is in the float state and the one or more safety conditions are satisfied. The method may include recording or transmitting a control state log associated with the first control valve, wherein the control state log includes at least one of: an attempted transition into the float state, a status of the electronically controlled locking device, an activation of the manual override mechanism, or a state of the electronically controlled blocking valve. The method may include supplying a command current to the first control valve to initiate a transition into the float state, measuring or interpreting a current feedback signal from at least one of a high-side driver or a low-side driver associated with the first control valve, comparing the command current to the current feedback signal to detect a fault condition associated with the attempted transition into the float state, and in response to detecting the fault condition, preventing the first control valve from transitioning into the float state and initiating one or more safety precautions.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a schematic diagram of a hydraulic system for controlling multiple hydraulic actuators, according to aspects of the present disclosure.

FIG. 2 illustrates a hydraulic control system circuit diagram for controlling multiple hydraulic actuators in a machine.

FIG. 3 illustrates a hydraulic control circuit configured for controlling multiple hydraulic actuators in a machine.

FIG. 4 illustrates a hydraulic control circuit configured for controlling multiple hydraulic actuators through a series of control valves.

FIG. 5 illustrates a hydraulic control system configured to control multiple hydraulic actuators through a valve assembly.

FIG. 6 illustrates a hydraulic control system configured to control multiple hydraulic actuators through a series of control valves.

FIG. 7 illustrates a hydraulic control system configured to control multiple hydraulic actuators through a series of control valves, according to aspects of the present disclosure.

FIG. 8 illustrates a side view of a working machine.

FIG. 9 illustrates a schematic diagram of a control system for a work machine.

FIG. 10 illustrates a flowchart for a method for controlling the transition to a float state in a hydraulic control system.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

A hydraulic system for a machine is configured to control multiple hydraulic actuators in working machines such as skid steer loaders, compact wheel loaders, and similar equipment. The hydraulic system includes a tank operable to store a hydraulic fluid, which serves as a reservoir for the hydraulic fluid used throughout the system. A first pump operable to output a flow of hydraulic fluid provides pressurized fluid to operate various components within the hydraulic system.

The hydraulic system includes a first hydraulic actuator to be operated by the hydraulic fluid having a first fluid port for supplying the hydraulic fluid to move the actuator in a first direction, and a second fluid port for supplying the hydraulic fluid to move the actuator in a second direction. The first hydraulic actuator is typically configured to control mechanical devices such as boom linkage systems. A second hydraulic actuator to be operated by the hydraulic fluid having a third fluid port for supplying the hydraulic fluid to move the actuator in a first direction, and a fourth fluid port for supplying the hydraulic fluid to move the actuator in a second direction is also provided. The second hydraulic actuator is configured to control additional mechanical devices such as bucket assemblies or auxiliary attachments.

A first control valve controllable among a plurality of states including at least a first state and a second state to control the first hydraulic actuator directs hydraulic fluid flow to and from the first hydraulic actuator. A second control valve disposed downstream of the first control valve and controllable among a plurality of states including at least a first state and a second state to control the second hydraulic actuator similarly controls fluid flow for the second hydraulic actuator. The control valves are arranged in a series configuration where hydraulic fluid flows sequentially through each valve section, allowing return flow from an upstream actuator to be directed to a downstream actuator.

The hydraulic system architecture addresses a challenge encountered in machines that incorporate float functionality alongside load-holding valves. Float mode allows hydraulic actuators to move freely in response to external forces by connecting both fluid ports of an actuator to tank pressure, enabling implements to follow ground contours during operations such as grading or snow removal. However, load-holding valves such as pilot-operated check valves or counterbalance valves, which prevent actuator drift and provide safety functionality, typically require minimum pilot pressure to open and allow reverse flow. In float mode, system pressure is reduced or routed to tank, resulting in insufficient pilot pressure to actuate these load-holding valves, thereby disabling float functionality.

The hydraulic system addresses this challenge through a solution approach involving dedicated float passages and bypass connections that enable float operation while maintaining load-holding capabilities. The first control valve comprises multiple connections and passages configured to selectively establish fluid communication paths depending on the valve state. Float passages are configured to be fluidly connected downstream of load-holding valves, providing alternate flow paths that bypass the load-holding valves when float functionality is activated. Bypass connections within the control valves enable these float passages to communicate with tank when the control valve is positioned in a float state, allowing both fluid ports of an actuator to drain to tank and enabling free movement in response to external forces.

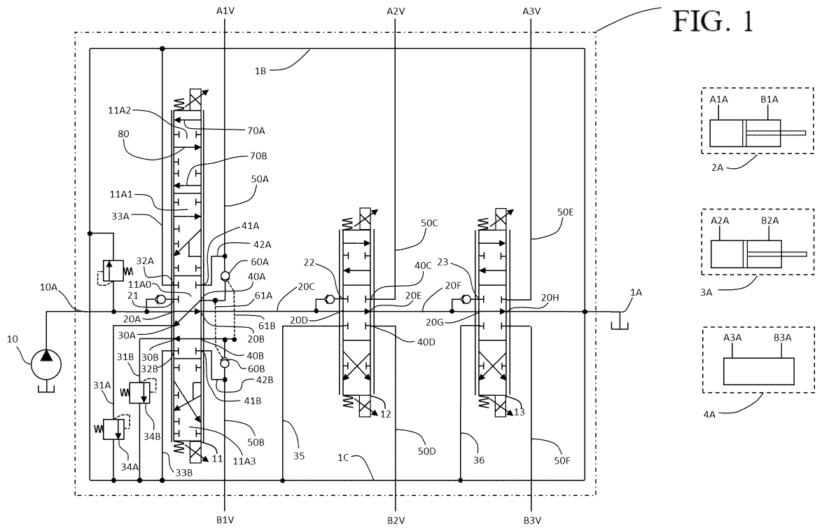

Referring to FIG. 1, a first embodiment of the hydraulic system is illustrated. The hydraulic system includes a tank 1A configured to store hydraulic fluid and connected to a first tank passage 1B and a second tank passage 1C for returning hydraulic fluid to the tank 1A. A pump 10 is operable to output a flow of hydraulic fluid through a supply passage 10A to provide pressurized fluid throughout the hydraulic system.

The hydraulic system includes a valve assembly V1 comprising a first control valve 11, a second control valve 12, and a third control valve 13 arranged in a series configuration. The first control valve 11 is fluidly connected to a hydraulic boom cylinder 2A, which serves as the first hydraulic actuator for controlling boom movement. The hydraulic boom cylinder 2A includes a first actuator base port A1A and a first actuator rod port B1A for receiving and expelling hydraulic fluid during extension and retraction operations. The second control valve 12 is fluidly connected to a hydraulic bucket cylinder 3A, which functions as the second hydraulic actuator for controlling bucket operations. The hydraulic bucket cylinder 3A includes a second actuator base port A2A and a second actuator rod port B2A. The third control valve 13 is connected to a hydraulic auxiliary cylinder 3S and an auxiliary actuator 4A, which includes a third actuator base port A3A and a third actuator rod port B3A for operating auxiliary attachments.

The first control valve 11 includes a first free flow connection 20A that receives hydraulic fluid from the supply passage 10A and is fluidly connectable to a second free flow connection 20B. The second free flow connection 20B is fluidly connected to a first free flow passage 20C, which directs hydraulic fluid downstream to the second control valve 12. The second control valve 12 includes a third free flow connection 20D that receives fluid from the first free flow passage 20C and a fourth free flow connection 20E that connects to a fifth free flow connection 20F of the third control valve 13. The third control valve 13 includes a sixth free flow connection 20G that connects to a second free flow passage 20H, which returns hydraulic fluid to the tank 1A through the second tank passage 1C.

The hydraulic system is configured as an open-center valve configuration, in which hydraulic fluid flows through a central passage when the spools are in the neutral position. This configuration allows hydraulic fluid to pass through each control valve section when the valves are not actuated, enabling sequential flow through the valve assembly V1. The hydraulic system is implemented as a series circuit, in which multiple functions are connected hydraulically in series, allowing simultaneous operation of multiple actuators using return flow from upstream actuators.

A supply connection 21 is provided within the first control valve 11 and is configured to receive pressurized fluid from the pump 10 through the supply passage 10A. The supply connection 21 is selectively fluidly connectable to one or more working connections depending on a state of the first control valve 11. The second control valve 12 includes a second supply connection 22, and the third control valve 13 includes a third supply connection 23, each configured to receive pressurized fluid when the respective control valve is actuated.

The first control valve 11 includes a first working connection 40A and a second working connection 40B, each fluidly connected to a respective first fluid port and second fluid port via a corresponding first working passage 50A and second working passage 50B. The first working passage 50A connects the first working connection 40A to a first base port A1V, which interfaces with the first actuator base port A1A of the hydraulic boom cylinder 2A. The second working passage 50B connects the second working connection 40B to a first rod port BIV, which interfaces with the first actuator rod port BIA of the hydraulic boom cylinder 2A. The second control valve 12 similarly includes a third working connection 40C and a fourth working connection 40D connected through a third working passage 50C and a fourth working passage 50D to a second base port A2V and a second rod port B2V, respectively. The third control valve 13 includes a fifth working passage 50E and a sixth working passage 50F connected to a third base port A3V and a third rod port B3V, respectively.

The first control valve 11 includes a first bypass connection 30A and a second bypass connection 30B, which function as primary bypass connections fluidly connected to a first bypass passage 31A and a second bypass passage 31B, respectively. The first bypass passage 31A and the second bypass passage 31B function as primary bypass passages that are fluidly connected to the tank 1A through the first tank passage 1B and the second tank passage 1C. The bypass connections and passages provide return paths for hydraulic fluid to flow back to the tank 1A when the control valves are in certain operational states, enabling proper fluid circulation throughout the hydraulic system.

With continued reference to FIG. 1, the first control valve 11 includes a first float connection 41A and a second float connection 41B that enable float functionality within the hydraulic system. The first float connection 41A is fluidly connected to a first float passage 42A, and the second float connection 41B is fluidly connected to a second float passage 42B. The float passages 42A and 42B are configured to be fluidly connected to the first working passage 50A and the second working passage 50B, respectively, with the connection being located downstream of load holding valves disposed in-line with the working passages.

A first pilot-operated check valve 60A is disposed in-line with the first working passage 50A, and a second pilot-operated check valve 60B is disposed in-line with the second working passage 50B. The pilot-operated check valves 60A and 60B function as load control valves that permit flow from the first control valve 11 to the first working passage 50A and the second working passage 50B in a forward direction but restrict reverse flow unless sufficient pilot pressure is applied to open the valves. The first pilot-operated check valve 60A is configured to allow free flow in one direction while requiring pilot pressure to permit reverse flow, thereby preventing unintended actuator movement under load. A first pilot line 61A provides pilot pressure to the first pilot-operated check valve 60A, and a pilot passage 90A supplies pilot pressure to the system.

The first float passage 42A is fluidly connected to the first working passage 50A downstream of the first pilot-operated check valve 60A, thereby providing an alternate path for hydraulic fluid to flow to tank when the first control valve 11 is in a float state. Similarly, the second float passage 42B is fluidly connected to the second working passage 50B downstream of the second pilot-operated check valve 60B, providing an alternate flow path that bypasses the load-holding functionality of the second pilot-operated check valve 60B.

The first control valve 11 further includes a first float bypass connection 32A and a second float bypass connection 32B that are selectively fluidly connectable to the first float connection 41A and the second float connection 41B depending on the valve state. The first float bypass connection 32A is fluidly connected to a first float bypass passage 33A, and the second float bypass connection 32B is fluidly connected to a second float bypass passage 33B. The first float bypass passage 33A and the second float bypass passage 33B are fluidly connected to the tank 1A through the first tank passage 1B and the second tank passage 1C, providing return paths for hydraulic fluid during float operation.

As further shown in FIG. 1, a first valve 34A is disposed within the first bypass passage 31A, and a second valve 34B is disposed within the second bypass passage 31B. The first valve 34A and the second valve 34B provide additional flow control functionality within the bypass passages, although these components are not required for float operation. The second control valve 12 includes a third float bypass passage 35, and the third control valve 13 includes a fourth float bypass passage 36, which provide similar float functionality for the downstream control valves.

A control element 80 is positioned within the first control valve 11 and is operable among multiple states to establish different fluid communication paths. The control element 80 is controllable among a plurality of states including a lowering state 11A1, a float state 11A2, and a lifting state 11A3. Each of the free flow connections, the supply connection 21, the working connections, the first bypass connection 30A and the second bypass connection 30B functioning as primary bypass connections, and the first float connection 41A and the second float connection 41B are positioned proximate to the control element 80 within the first control valve 11 at one or more locations thereon, and are selectively fluidly connectable to one or more of the others depending on a state of the first control valve 11.

In a first state, the first control valve 11 is configured to allow fluid communication between the first free flow connection 20A and the second free flow connection 20B, such that fluid output from the pump 10 flows through the first control valve 11 to the third free flow connection 20D of the second control valve 12. In this first state, the first control valve 11 either fluidly connects at least one of the working connections to the primary bypass connection or fluidly blocks at least one of the working connections from the primary bypass connection. The first control valve 11 is further configured to block fluid communication between the first float connection 41A and the second float connection 41B and either the primary bypass connection or a dedicated float bypass connection when the control element 80 is not in the float state 11A2.

In a second state corresponding to the lowering state 11A1, the first control valve 11 is configured to fluidly connect the supply connection 21 to at least one of the working connections to direct pressurized fluid for actuating a function of an actuator. The first control valve 11 fluidly isolates the first float connection 41A and the second float connection 41B from at least one of the primary bypass connection or a dedicated float bypass connection, thereby ensuring that the actuator operates under controlled pressure rather than gravity-induced float movement.

In a third state corresponding to the float state 11A2, the first control valve 11 is configured to fluidly connect at least one of the working connections to the first float bypass connection 32A and the second float bypass connection 32B, thereby permitting flow from the actuator to the tank 1A via the first float passage 42A and the second float passage 42B. A first fluidic connection 70A is established between the first float connection 41A and the first float bypass connection 32A, and a second fluidic connection 70B is established between the second float connection 41B and the second float bypass connection 32B. The first control valve 11 fluidly isolates the supply connection 21 to prevent active pressure delivery to the working connections, and fluidly connects the first free flow connection 20A to the second free flow connection 20B, thereby allowing fluid to pass through the first control valve 11 to the third free flow connection 20D of the second control valve 12 while in the third state.

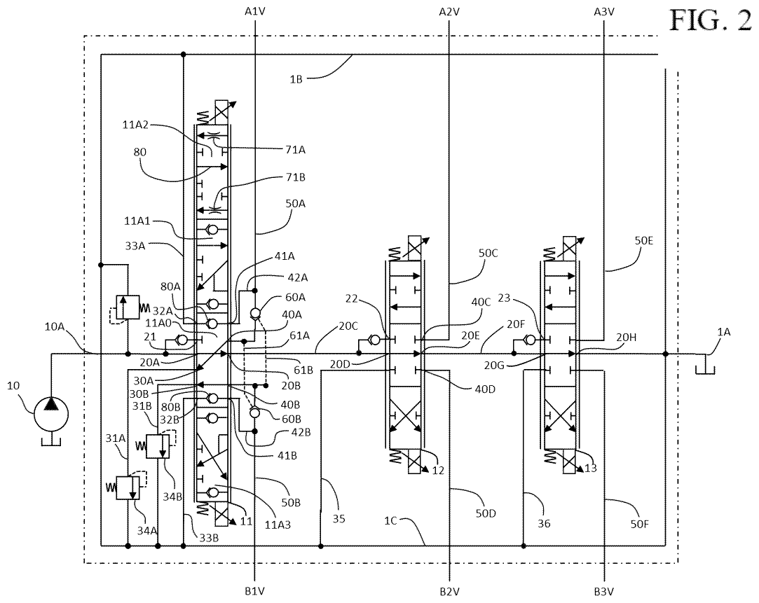

Referring to FIG. 2, a second embodiment of the hydraulic system is illustrated with a modified configuration for controlling float functionality. The hydraulic system includes the same basic components as the first embodiment, including the tank 1A, the pump 10, the supply passage 10A, and the valve assembly V1 comprising the first control valve 11, the second control valve 12, and the third control valve 13. The first control valve 11 is connected to the hydraulic boom cylinder 2A through the first base port A1V and the first rod port B1V, and includes the same working passages, bypass passages, and float passages as described in the first embodiment.

The second embodiment differs from the first embodiment in the configuration of elements between the first float connection 41A and the second float connection 41B and the first float bypass connection 32A and the second float bypass connection 32B. A first check valve 80A is disposed between the first float connection 41A and the first float bypass connection 32A, and a second check valve 80B is disposed between the second float connection 41B and the second float bypass connection 32B. The first check valve 80A and the second check valve 80B are positioned within the control element 80 of the first control valve 11.

The first check valve 80A is oriented to prevent flow from the first float connection 41A toward the first float bypass connection 32A during non-float states of the first control valve 11. Similarly, the second check valve 80B is oriented to prevent flow from the second float connection 41B toward the second float bypass connection 32B when the first control valve 11 is not in the float state 11A2. The first check valve 80A and the second check valve 80B permit reverse flow from the first float bypass connection 32A and the second float bypass connection 32B to the first float connection 41A and the second float connection 41B, respectively, when pressure at the float bypass connections exceeds that of the float connections.

The first control valve 11 is configured to include the first check valve 80A and the second check valve 80B disposed within the control element 80. In the first and second states of the first control valve 11, the first check valve 80A and the second check valve 80B are configured to prevent fluid flow from the first float connection 41A and the second float connection 41B to the first float bypass connection 32A and the second float bypass connection 32B, respectively. The first check valve 80A and the second check valve 80B are further configured, in the third state corresponding to the float state 11A2, to permit fluid communication between the first float connection 41A and the second float connection 41B and the first float bypass connection 32A and the second float bypass connection 32B in both directions.

As further shown in FIG. 2, a first restriction 71A is disposed between the first float connection 41A and the first float bypass connection 32A to regulate the rate of flow during float operation. A second restriction 71B is disposed between the second float connection 41B and the second float bypass connection 32B for similar flow control purposes. The first restriction 71A and the second restriction 71B function as orifices that regulate the rate of flow to the tank 1A, thereby providing a controlled float response and damping during float operation.

The first restriction 71A and the second restriction 71B are disposed within the first control valve 11 between the first float connection 41A and the second float connection 41B and the first float bypass connection 32A and the second float bypass connection 32B, respectively. The first restriction 71A and the second restriction 71B are formed within the control element 80 of the first control valve 11 and are configured to restrict fluid flow between the first float connection 41A and the second float connection 41B and the first float bypass connection 32A and the second float bypass connection 32B. The restrictions allow the float response to be tuned based on application requirements, providing damping to control the rate of float response and enhance operational stability.

The first pilot-operated check valve 60A remains disposed in-line with the first working passage 50A, and the second pilot-operated check valve 60B remains disposed in-line with the second working passage 50B. A second pilot line 61B provides pilot pressure to the second pilot-operated check valve 60B, similar to how the first pilot line 61A provides pilot pressure to the first pilot-operated check valve 60A. The pilot-operated check valves 60A and 60B continue to function as load control valves that permit flow in a forward direction while restricting reverse flow unless sufficient pilot pressure is applied.

In the float state 11A2, the first check valve 80A and the second check valve 80B are effectively bypassed or rendered inactive, enabling unrestricted fluid communication between the first float connection 41A and the second float connection 41B and the first float bypass connection 32A and the second float bypass connection 32B, respectively. The first restriction 71A and the second restriction 71B provide damping during float operation while allowing both the first base port A1V and the first rod port BIV to be connected to the tank 1A through the first float passage 42A and the second float passage 42B and the first float bypass passage 33A and the second float bypass passage 33B.

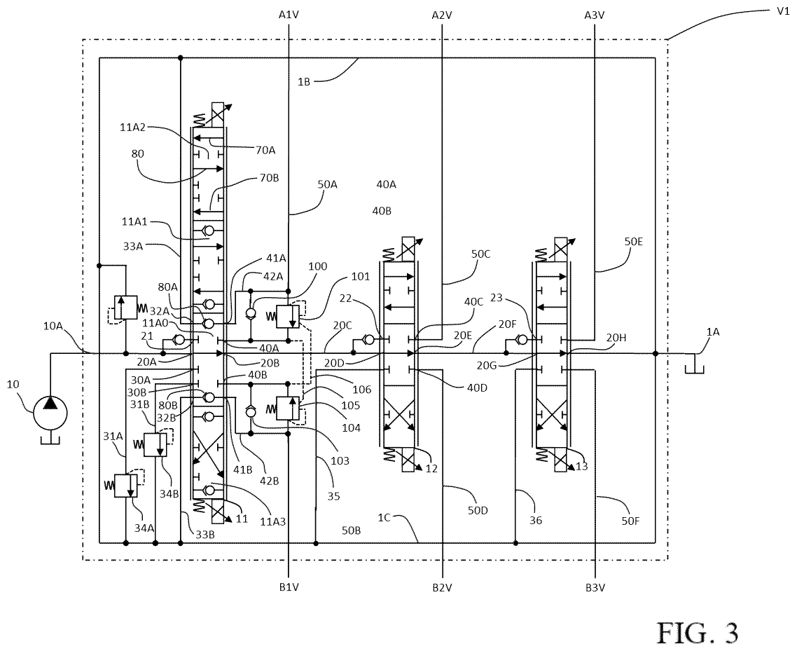

Referring to FIG. 3, a third embodiment of the hydraulic system is illustrated with counterbalance valve assemblies replacing the pilot-operated check valves of the previous embodiments. The hydraulic system includes the same basic components as the previous embodiments, including the tank 1A, the pump 10, the supply passage 10A, and the valve assembly V1 comprising the first control valve 11, the second control valve 12, and the third control valve 13. The first control valve 11 remains connected to the hydraulic boom cylinder 2A through the first base port AV and the first rod port B1V, and includes the same working passages, bypass passages, and float passages as described in the previous embodiments.

The third embodiment differs from the previous embodiments in the configuration of load control valves disposed within the working passages. A first free-flow check valve 100 and a first pilot-operated relief valve 101 are positioned in the first working passage 50A, forming a counterbalance valve assembly. Similarly, a second free-flow check valve 103 and a second pilot-operated relief valve 104 are positioned in the second working passage 50B, forming another counterbalance valve assembly. The counterbalance valve assemblies replace the first pilot-operated check valve 60A and the second pilot-operated check valve 60B of the previous embodiments.

The first free-flow check valve 100 permits free flow in one direction from the first control valve 11 toward the first base port AV while preventing reverse flow. The first pilot-operated relief valve 101 is configured to maintain backpressure in the first working passage 50A until sufficient pilot pressure is applied to open the valve and allow reverse flow. The combination of the first free-flow check valve 100 and the first pilot-operated relief valve 101 provides load-holding and overrun protection by maintaining controlled backpressure in the hydraulic system.

The second free-flow check valve 103 and the second pilot-operated relief valve 104 function similarly within the second working passage 50B. The second free-flow check valve 103 permits free flow from the first control valve 11 toward the first rod port BIV while preventing reverse flow. The second pilot-operated relief valve 104 maintains backpressure in the second working passage 50B until sufficient pilot pressure is applied to open the valve. The counterbalance valve assemblies prevent unintended actuator movement under load while providing controlled pressure relief when pilot pressure is applied.

With continued reference to FIG. 3, the second control valve 12 includes similar counterbalance valve assemblies with a third pilot-operated relief valve 105 and a fourth pilot-operated relief valve 106. The third pilot-operated relief valve 105 is positioned within the third working passage 50C to control flow to the second base port A2V, and the fourth pilot-operated relief valve 106 is positioned within the fourth working passage 50D to control flow to the second rod port B2V. The counterbalance valve assemblies within the second control valve 12 provide the same load-holding and overrun protection functionality for the hydraulic bucket cylinder 3A.

The first float passage 42A remains fluidly connected to the first working passage 50A downstream of the counterbalance valve assembly comprising the first free-flow check valve 100 and the first pilot-operated relief valve 101. The second float passage 42B remains fluidly connected to the second working passage 50B downstream of the counterbalance valve assembly comprising the second free-flow check valve 103 and the second pilot-operated relief valve 104. The float passages provide alternate flow paths that bypass the load-holding functionality of the counterbalance valve assemblies when the first control valve 11 is positioned in the float state 11A2.

The first check valve 80A remains disposed between the first float connection 41A and the first float bypass connection 32A, and the second check valve 80B remains disposed between the second float connection 41B and the second float bypass connection 32B. In the float state 11A2, the first fluidic connection 70A is established between the first float connection 41A and the first float bypass connection 32A, and the second fluidic connection 70B is established between the second float connection 41B and the second float bypass connection 32B. The float passages enable float operation by allowing hydraulic fluid from both the first base port A1V and the first rod port B1V to flow to the tank 1A through the first float bypass passage 33A and the second float bypass passage 33B, bypassing the counterbalance valve assemblies and allowing the hydraulic boom cylinder 2A to move freely in response to external forces.

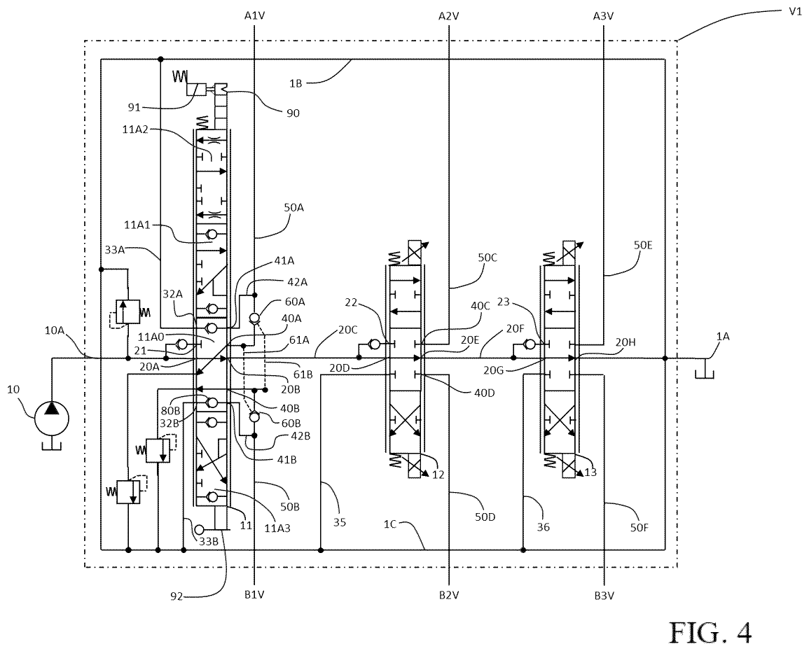

Referring to FIG. 4, a fourth embodiment of the hydraulic system is illustrated with a mechanically actuated configuration for the first control valve 11. The hydraulic system includes the same basic components as the previous embodiments, including the tank 1A, the pump 10, the supply passage 10A, and the valve assembly V1 comprising the first control valve 11, the second control valve 12, and the third control valve 13. The first control valve 11 remains connected to the hydraulic boom cylinder 2A through the first base port A1V and the first rod port B1V, and includes the same working passages, bypass passages, and float passages as described in the previous embodiments.

The fourth embodiment differs from the previous embodiments in the actuation method for the first control valve 11. A control lever 92 is provided for mechanically actuating the first control valve 11 rather than through electronic means. The control lever 92 is mechanically linked to the control element 80 within the first control valve 11, allowing an operator to manually position the first control valve 11 among multiple operational states including a neutral state 11A0, the lowering state 11A1, the float state 11A2, and the lifting state 11A3. The control lever 92 provides direct mechanical control over the position of the control element 80, enabling the operator to establish different fluid communication paths within the first control valve 11.

A detent mechanism 90 is integrated with the control lever 92 to allow the operator to position the first control valve 11 into the float state 11A2 and maintain that position without continued manual input. The detent mechanism 90 holds the control lever 92 and the control element 80 in the float state 11A2 until displaced by a deliberate operator action. The detent mechanism 90 enables the operator to maintain the first control valve 11 in the float state 11A2 without continuous manual force on the control lever 92, allowing for sustained float operation during grading, snow removal, or back dragging operations.

An electromechanical spool lock 91 is disposed in association with the first control valve 11 and is configured to selectively restrict movement of the control element 80 into certain states. The electromechanical spool lock 91 functions as an electronically controlled locking device that is configured to mechanically prevent the first control valve 11 from transitioning into the third state corresponding to the float state 11A2, thereby preventing the first float connection 41A and the second float connection 41B from being fluidly connected to either the first bypass connection 30A and the second bypass connection 30B functioning as primary bypass connections or the first float bypass connection 32A and the second float bypass connection 32B functioning as float bypass connections.

The electromechanical spool lock 91 is configured to engage with the control lever 92 or the control element 80 to mechanically prevent transition into the float state 11A2 unless specific conditions are satisfied. The electromechanical spool lock 91 comprises an electromechanical actuator configured to selectively engage or disengage a mechanical lock that restricts movement of the control element 80 into the third state corresponding to the float state 11A2. The electromechanical spool lock 91 provides a safety mechanism to prevent unintended actuation of the float function, particularly when the machine is powered off or when operator presence is not detected.

With continued reference to FIG. 4, the electromechanical spool lock 91 is actuated in response to one or more control signals corresponding to operating conditions of the machine. The control signals comprise at least one of an operator presence signal, a vehicle speed signal, a machine orientation signal, or a control system logic condition. The electromechanical spool lock 91 engages automatically based on operator presence, machine speed, orientation, or other system inputs to prevent unintended float activation due to accidental lever movement or component failure.

The electromechanical spool lock 91 further comprises a manual override mechanism configured to enable operator-initiated disengagement of the mechanical lock independently of the control signals. The manual override mechanism allows the electromechanical spool lock 91 to be disengaged under specific circumstances, such as during maintenance or fault recovery operations. The manual override mechanism provides a backup method for accessing float functionality when electronic control systems are not operational or when maintenance procedures require manual control of the first control valve 11.

The first control valve 11 remains operable among the multiple states as described in the previous embodiments. In the neutral state 11A0, the first free flow connection 20A is fluidly connected to the second free flow connection 20B through the first free flow passage 20C, allowing fluid to pass downstream to the second control valve 12. In the lowering state 11A1, the supply connection 21 is fluidly connected to one of the working connections to direct pressurized fluid to the hydraulic boom cylinder 2A. In the lifting state 11A3, the supply connection 21 is fluidly connected to the other working connection to extend the hydraulic boom cylinder 2A in the opposite direction. In the float state 11A2, when the electromechanical spool lock 91 is disengaged, the first float connection 41A and the second float connection 41B are fluidly connected to the first float bypass connection 32A and the second float bypass connection 32B, allowing both the first base port A1V and the first rod port B1V to communicate with the tank 1A through the first float bypass passage 33A and the second float bypass passage 33B.

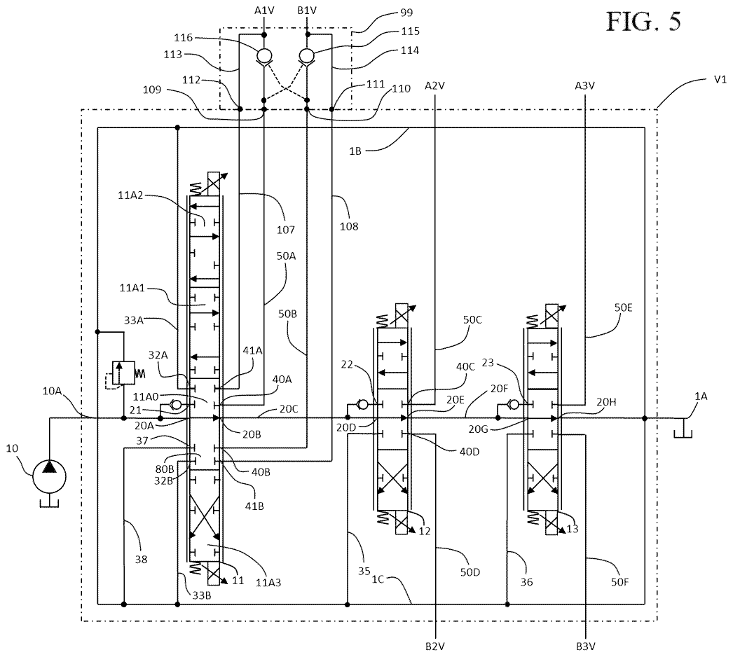

Referring to FIG. 5, a fifth embodiment of the hydraulic system is illustrated with an external float port configuration that routes float passages to dedicated external ports rather than connecting them internally to working passages within the valve body. The hydraulic system includes the same basic components as the previous embodiments, including the tank 1A, the pump 10, the supply passage 10A, and the valve assembly V1 comprising the first control valve 11, the second control valve 12, and the third control valve 13. The first control valve 11 remains connected to control the hydraulic boom cylinder 2A and includes the same working connections and bypass connections as described in the previous embodiments.

The fifth embodiment differs from the previous embodiments in the routing and configuration of float passages within the hydraulic system. The first float connection 41A is fluidly connected to a first float passage 107, and the second float connection 41B is fluidly connected to a second float passage 108. The first float passage 107 and the second float passage 108 are not internally connected to the first working passage 50A and the second working passage 50B within the valve body of the first control valve 11. Instead, the first float passage 107 terminates at a first manifold float port 111, and the second float passage 108 terminates at a second manifold float port 112, which function as dedicated float ports that are positioned externally to the valve assembly V1.

The first working connection 40A is fluidly connected to the first working passage 50A, which terminates at a first manifold working port 109, and the second working connection 40B is fluidly connected to the second working passage 50B, which terminates at a second manifold working port 110. The first manifold working port 109, the second manifold working port 110, the first manifold float port 111, and the second manifold float port 112 are positioned on the same face of the valve assembly V1, allowing for a seamless flanged interface with integrated sealing features to prevent external fluid leakage and simplify installation.

A flanged manifold 99 is provided that interfaces with the external ports of the first control valve 11. The flanged manifold 99 functions as an auxiliary body that includes corresponding float passages and working passages, and includes load holding valves disposed within the working passages. The first manifold working port 109 and the second manifold working port 110 are in fluid communication with the flanged manifold 99, establishing fluid connections between the working connections of the first control valve 11 and the working passages of the flanged manifold 99.

With continued reference to FIG. 5, the flanged manifold 99 includes a third float passage 113 and a fourth float passage 114 that are fluidly connected to the first manifold float port 111 and the second manifold float port 112, respectively. The third float passage 113 and the fourth float passage 114 function as float passages internal to the flanged manifold 99 and provide alternate flow paths for hydraulic fluid during float operation. The flanged manifold 99 further includes working passages that connect the first manifold working port 109 and the second manifold working port 110 to final working ports configured to be fluidly connected to the hydraulic boom cylinder 2A.

A first pilot-operated check valve 115 is disposed within the flanged manifold 99 in-line with the working passage leading to the first base port A1V, and a second pilot-operated check valve 116 is disposed within the flanged manifold 99 in-line with the working passage leading to the first rod port B1V. The first pilot-operated check valve 115 and the second pilot-operated check valve 116 function as load holding valves that permit flow from the first control valve 11 toward the hydraulic boom cylinder 2A in a forward direction but restrict reverse flow unless sufficient pilot pressure is applied to open the valves.

The third float passage 113 is fluidly connected downstream of the first pilot-operated check valve 115, and the fourth float passage 114 is fluidly connected downstream of the second pilot-operated check valve 116. The float passages internal to the flanged manifold 99 are fluidly connected downstream of the in-line load holding valves, thereby providing alternate paths for hydraulic fluid to flow from the working passages to the first float passage 107 and the second float passage 108 when the first control valve 11 is in the float state 11A2. The configuration enables the load holding valves to be positioned outside the main valve body while maintaining float functionality.

The first control valve 11 includes a first bypass connection 37 connected to a first bypass passage 38, providing an additional return path to the tank 1A. The second check valve 80B remains disposed within the first control valve 11 to regulate flow between the second float connection 41B and the second float bypass connection 32B, preventing reverse flow in certain valve states while permitting bidirectional flow when the first control valve 11 is in the float state 11A2.

As further shown in FIG. 5, when the first control valve 11 is positioned in the float state 11A2, the first float connection 41A and the second float connection 41B are fluidly connected to the first float bypass connection 32A and the second float bypass connection 32B, respectively. The fluid communication established through the first float passage 107, the second float passage 108, the third float passage 113, and the fourth float passage 114 allows both the first base port A1V and the first rod port BIV to communicate with the tank 1A through the first float bypass passage 33A and the second float bypass passage 33B. The modular arrangement of the flanged manifold 99 enables the first pilot-operated check valve 115 and the second pilot-operated check valve 116 to be positioned externally to the valve assembly V1 while maintaining the ability to selectively connect both sides of the hydraulic boom cylinder 2A to the tank 1A during float operation, thereby enabling float functionality even in the presence of load-holding valves.

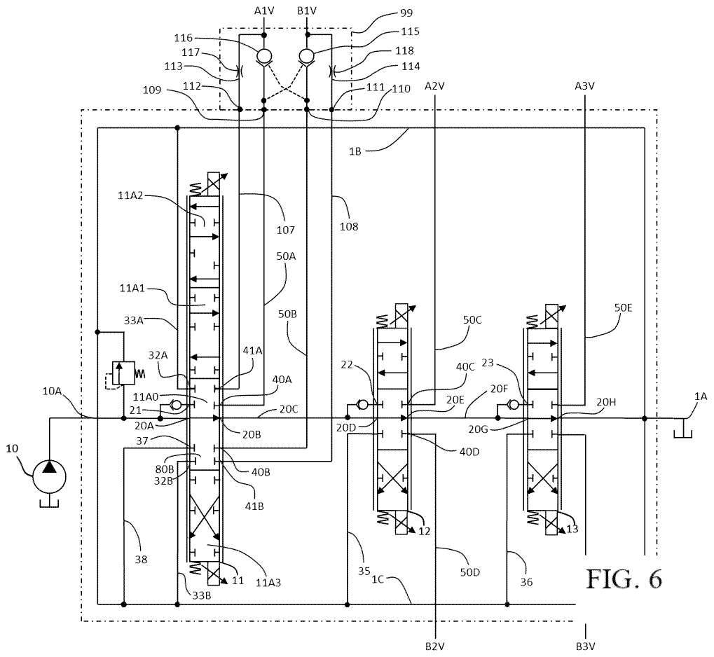

Referring to FIG. 6, a sixth embodiment of the hydraulic system is illustrated with restrictions disposed within float passages of the flanged manifold 99 to provide controlled damping during float operation. The hydraulic system includes the same basic components as the previous embodiments, including the tank 1A, the pump 10, the supply passage 10A, and the valve assembly V1 comprising the first control valve 11, the second control valve 12, and the third control valve 13. The first control valve 11 remains connected to control the hydraulic boom cylinder 2A through the first base port A1V and the first rod port B1V, and includes the same working connections, bypass connections, and float connections as described in the previous embodiments.

The sixth embodiment differs from the fifth embodiment in the incorporation of flow restrictions within the float passages of the flanged manifold 99. A first restriction 117 is disposed in the third float passage 113 within the flanged manifold 99, and a second restriction 118 is disposed in the fourth float passage 114 within the flanged manifold 99. The first restriction 117 and the second restriction 118 function as orifices that regulate the rate of flow to the tank 1A during float operation, thereby providing controlled float response and enhanced operational stability.

The first restriction 117 is positioned within the third float passage 113 downstream of the first pilot-operated check valve 115, and the second restriction 118 is positioned within the fourth float passage 114 downstream of the second pilot-operated check valve 116. The first restriction 117 and the second restriction 118 are configured to restrict fluid flow between the working passages and the first float passage 107 and the second float passage 108, respectively, when the first control valve 11 is positioned in the float state 11A2. The restrictions control the rate at which hydraulic fluid flows from the first base port A1V and the first rod port B1V to the tank 1A through the float passages.

With continued reference to FIG. 6, the first restriction 117 and the second restriction 118 provide controlled damping to regulate the rate of float movement of the hydraulic boom cylinder 2A. The restrictions enhance stability during backdragging operations by preventing excessive oscillation or rapid movement of the boom 123 when the bucket 125 encounters varying ground contours. The first restriction 117 and the second restriction 118 also limit the rate of boom descent due to gravity when the first control valve 11 is positioned in the float state 11A2, preventing uncontrolled dropping of the boom 123 and attached implements.

The first restriction 117 and the second restriction 118 are selected or tuned to achieve a desired level of damping based on the specific application requirements and machine characteristics. The restrictions enable the float characteristics to be directly influenced by the manifold design, providing controlled flow rates that ensure smoother operation across varying terrain conditions. The first restriction 117 and the second restriction 118 allow the hydraulic system to maintain float functionality while providing predictable and controlled movement characteristics that enhance operator control and machine stability.

As further shown in FIG. 6, the flanged manifold 99 maintains the same configuration as described in the fifth embodiment, with the first manifold working port 109, the second manifold working port 110, the first manifold float port 111, and the second manifold float port 112 providing fluid communication between the first control valve 11 and the flanged manifold 99. The first pilot-operated check valve 115 and the second pilot-operated check valve 116 continue to function as load holding valves within the flanged manifold 99, preventing reverse flow unless sufficient pilot pressure is applied.

When the first control valve 11 is positioned in the float state 11A2, the first float connection 41A and the second float connection 41B are fluidly connected to the first float bypass connection 32A and the second float bypass connection 32B, respectively. Hydraulic fluid flows from the first base port A1V through the third float passage 113, past the first restriction 117, through the first float passage 107, and to the tank 1A via the first float bypass passage 33A. Similarly, hydraulic fluid flows from the first rod port B1V through the fourth float passage 114, past the second restriction 118, through the second float passage 108, and to the tank 1A via the second float bypass passage 33B. The first restriction 117 and the second restriction 118 regulate these flow rates to provide controlled float operation while maintaining the ability for the hydraulic boom cylinder 2A to move freely in response to external forces.

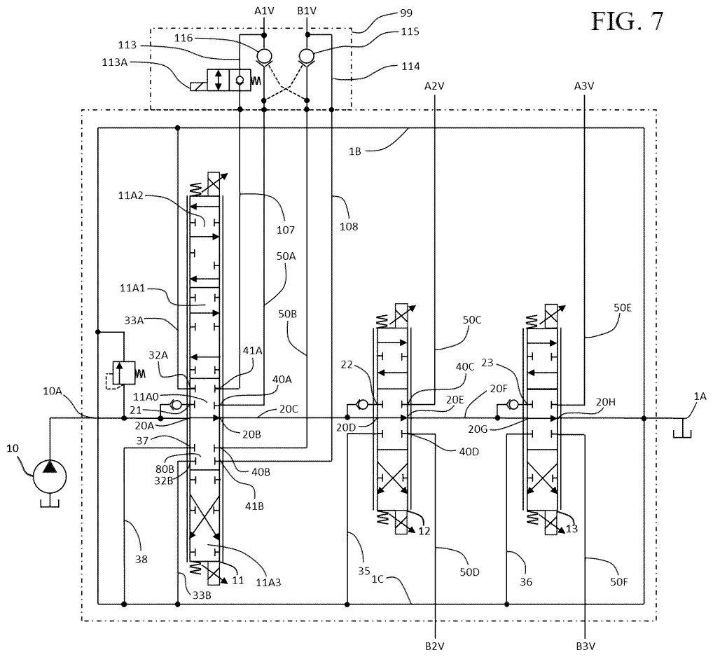

Referring to FIG. 7, a seventh embodiment of the hydraulic system is illustrated with an electronically controlled blocking valve configuration that provides additional safety functionality for float operation. The hydraulic system includes the same basic components as the previous embodiments, including the tank 1A, the pump 10, the supply passage 10A, and the valve assembly V1 comprising the first control valve 11, the second control valve 12, and the third control valve 13. The first control valve 11 remains connected to control the hydraulic boom cylinder 2A through the first base port A1V and the first rod port BIV, and includes the same working connections, bypass connections, and float connections as described in the previous embodiments.

The seventh embodiment differs from the sixth embodiment in the incorporation of an electronically controlled blocking valve within the float passages of the flanged manifold 99. A blocking valve 113A is disposed in the third float passage 113 within the flanged manifold 99. The blocking valve 113A functions as an electronically controlled blocking valve that is configured to selectively block or permit fluid flow from the flanged manifold 99 to the first control valve 11 based on a control state. The blocking valve 113A is positioned within the third float passage 113 downstream of the first pilot-operated check valve 115, providing hydraulic control over fluid communication between the working passages and the float passages.

The blocking valve 113A is configured to prevent fluid communication between the third float passage 113 and the first float passage 107 unless predetermined safety criteria are satisfied and the first control valve 11 is positioned in the float state 11A2. The blocking valve 113A provides hydraulic prevention of unintended float behavior by blocking flow from the first base port A1V to the tank 1A through the float passages when safety conditions are not met or when the first control valve 11 is not intentionally positioned in the float state 11A2. The blocking valve 113A serves as a secondary safety feature that operates independently of the mechanical safety mechanisms provided by the electromechanical spool lock 91.

With continued reference to FIG. 7, the blocking valve 113A is actuated to permit fluid communication only when the first control valve 11 is positioned in the float state 11A2 and predetermined safety conditions are satisfied. The predetermined safety conditions include operator presence signals, machine orientation conditions, vehicle speed thresholds, or control system logic conditions that ensure safe operation of the float function. The blocking valve 113A transitions from a blocked state to an open state when these safety criteria are met, allowing unrestricted float functionality through the third float passage 113.

The blocking valve 113A is configured to block the third float passage 113 when the first control valve 11 enters the float state 11A2 unintentionally or when safety criteria are not satisfied. The blocking valve 113A prevents hydraulic fluid from flowing from the first base port A1V through the third float passage 113, the first float passage 107, and to the tank 1A via the first float bypass passage 33A when the blocking valve 113A is in the blocked state. The blocking valve 113A provides redundant safety protection by ensuring that float functionality is disabled at the hydraulic level even if the first control valve 11 is positioned in the float state 11A2 due to mechanical failure, electrical fault, or unintended operator input.

As further shown in FIG. 7, the flanged manifold 99 maintains the same configuration as described in the previous embodiments, with the first manifold working port 109, the second manifold working port 110, the first manifold float port 111, and the second manifold float port 112 providing fluid communication between the first control valve 11 and the flanged manifold 99. The first pilot-operated check valve 115 and the second pilot-operated check valve 116 continue to function as load holding valves within the flanged manifold 99, preventing reverse flow unless sufficient pilot pressure is applied. The fourth float passage 114 remains configured to provide float functionality for the first rod port B1V, and additional blocking valves can be disposed within the fourth float passage 114 to provide similar safety functionality for both sides of the hydraulic boom cylinder 2A.

When the first control valve 11 is positioned in the float state 11A2 and the blocking valve 113A is commanded to the open state based on satisfied safety criteria, the first float connection 41A and the second float connection 41B are fluidly connected to the first float bypass connection 32A and the second float bypass connection 32B, respectively. Hydraulic fluid flows from the first base port A1V through the third float passage 113, past the blocking valve 113A in the open state, through the first float passage 107, and to the tank 1A via the first float bypass passage 33A. The blocking valve 113A enables controlled float operation while providing hydraulic-level safety protection that prevents unintended float activation and ensures that float functionality is available only when both the first control valve 11 is intentionally positioned in the float state 11A2 and predetermined safety conditions are satisfied.

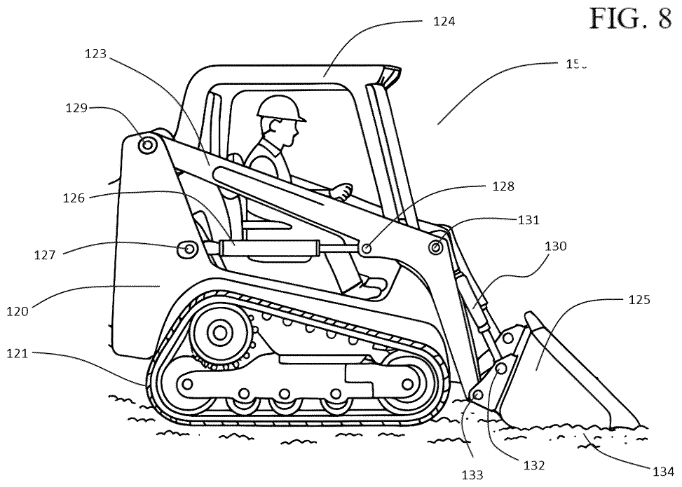

Referring to FIG. 8, a machine 150 is illustrated that represents an example of a working machine in which the hydraulic system described in the previous embodiments is implemented. The machine 150 includes a chassis 120 that serves as the main structural frame supporting various components of the machine 150. A cab 124 is positioned on the chassis 120 and is configured to house an operator and operator controls for operating the machine 150. The machine 150 is supported by a track 121, which provides mobility for the machine 150 across terrain and enables movement during various work operations.

A boom 123 is pivotally connected to the chassis 120 at a boom pivot point 129, allowing the boom 123 to rotate about the boom pivot point 129 during lifting and lowering operations. A boom cylinder 126 is provided to actuate the boom 123 and corresponds to the hydraulic boom cylinder 2A described in the previous embodiments. The boom cylinder 126 has a base end connected to the chassis 120 at a pivot point 127, and a rod end connected to the boom 123 at a pivot point 128. Extension of the boom cylinder 126 causes the boom 123 to rotate counterclockwise about the boom pivot point 129, resulting in lifting of the boom 123. Retraction of the boom cylinder 126 causes the boom 123 to rotate clockwise about the boom pivot point 129, resulting in lowering of the boom 123.

A bucket 125 is attached to the distal end of the boom 123 at a pivot point 133, enabling the bucket 125 to rotate relative to the boom 123. A bucket cylinder 130 is provided to control the orientation of the bucket 125 and corresponds to the hydraulic bucket cylinder 3A described in the previous embodiments. The bucket cylinder 130 has a base end connected to the boom 123 at a cylinder pivot point 131, and a rod end connected to the bucket 125 at a pivot point 132. Extension of the bucket cylinder 130 causes the bucket 125 to rotate clockwise about the pivot point 133, resulting in dumping operations where material is discharged from the bucket 125. Retraction of the bucket cylinder 130 causes the bucket 125 to rotate counterclockwise about the pivot point 133, resulting in curling operations where the bucket 125 is positioned to scoop or retain material.

The hydraulic system described in the previous embodiments is implemented within the machine 150 to control the boom cylinder 126 and the bucket cylinder 130. The first control valve 11 controls hydraulic fluid flow to and from the boom cylinder 126 through the first base port A1V and the first rod port BIV, enabling lifting and lowering operations of the boom 123. The second control valve 12 controls hydraulic fluid flow to and from the bucket cylinder 130 through the second base port A2V and the second rod port B2V, enabling dumping and curling operations of the bucket 125.

As further shown in FIG. 8, the bucket 125 is positioned to engage soil 134, illustrating the machine's capability to perform grading, material handling, and excavation operations on uneven terrain. Float functionality provided by the hydraulic system enables the bucket 125 to passively follow terrain irregularities during grading or backdragging operations. When the first control valve 11 is positioned in the float state 11A2, both the first base port A1V and the first rod port BIV of the boom cylinder 126 are connected to the tank 1A through the float passages described in the previous embodiments, allowing the boom 123 and the attached bucket 125 to move freely in response to ground contour variations.

The float functionality enables the bucket 125 to maintain contact with the soil 134 while accommodating changes in ground elevation without requiring continuous operator input to adjust the position of the boom 123. During backdragging operations, the bucket 125 is dragged across the soil 134 surface while the boom 123 responds to terrain variations through the float functionality, resulting in consistent surface finish and reduced stress on the boom cylinder 126 and structural components of the machine 150. The hydraulic system configuration described in the previous embodiments enables this float functionality while maintaining load-holding capabilities through the pilot-operated check valves, counterbalance valve assemblies, or other load control valves disposed within the working passages.

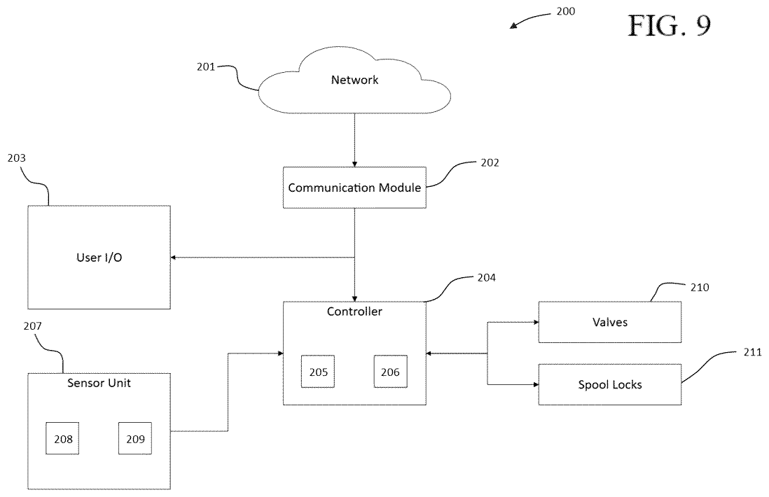

Referring to FIG. 9, a control system 200 is illustrated for managing the operation of the hydraulic system described in the previous embodiments. The control system 200 includes a controller 204 that serves as the central processing unit for managing system operations and controlling the various components of the hydraulic system. A communication module 202 is operatively connected to the controller 204 and is configured to facilitate data exchange between the control system 200 and external systems through a network 201. The network 201 enables communication with an external device 200, which provides remote monitoring, diagnostic capabilities, or operational data exchange for the hydraulic system.

A user interface 203 is provided within the control system 200 and is operatively connected to the controller 204. The user interface 203 allows an operator to input commands and receive feedback from the hydraulic system, enabling manual control of the first control valve 11, the second control valve 12, and the third control valve 13. The user interface 203 includes input mechanisms such as joysticks, levers, foot pedals, buttons, switches, or touchscreens that are positioned near the operator station within the cab 124 of the machine 150. Operator input received through the user interface 203 is transmitted to the controller 204 and translated into command signals for actuating the control valves.

The controller 204 is operatively connected to a first driver 205 and a second driver 206, which are configured to supply electrical current to various system components based on commands from the controller 204. The first driver 205 and the second driver 206 function as high-side or low-side drivers that provide controlled electrical current to valves 210 within the hydraulic system. The valves 210 include the first control valve 11, the second control valve 12, the third control valve 13, and associated components such as the blocking valve 113A described in the previous embodiments. The first driver 205 and the second driver 206 enable the controller 204 to achieve precise positioning of control elements within the valves 210 based on electrical input signals.

With continued reference to FIG. 9, a sensor unit 207 is provided within the control system 200 and includes a first sensor 208 and a second sensor 209. The sensor unit 207 is operatively connected to the controller 204 and provides feedback signals regarding system operating conditions. The first sensor 208 and the second sensor 209 monitor parameters such as pressure, position, temperature, spool position, or other relevant system variables within the hydraulic system. The controller 204 uses sensor feedback from the sensor unit 207 to adjust control outputs and maintain desired system performance, enabling closed-loop control of the hydraulic system components.

The control system 200 includes spool locks 211 that are operatively connected to the controller 204 and correspond to the electromechanical spool lock 91 described in the previous embodiments. The spool locks 211 are configured to mechanically restrict movement of valve spools within the valves 210 under certain conditions, preventing unintended transitions into the float state 11A2. The controller 204 commands the spool locks 211 to engage or disengage based on safety criteria, operator presence signals, machine orientation conditions, vehicle speed thresholds, or other predetermined conditions. The spool locks 211 provide mechanical-level safety protection that operates independently of hydraulic or electronic control systems.

The controller 204 includes integrated safety logic to prevent float activation of the first control valve 11 based on real-time machine or operator conditions. The integrated safety logic evaluates operator presence signals that indicate whether an operator is properly seated within the cab 124 or otherwise meets predefined safety conditions. The controller 204 inhibits float activation if the operator presence signal indicates that the operator is not properly seated or fails to meet the predefined safety condition, preventing unintended activation of the float state 11A2 that could result in uncommanded lowering of the boom 123 or attached implements.

As further shown in FIG. 9, the control system 200 implements fault detection by comparing command current supplied to the valves 210 with feedback signals received from the first driver 205 and the second driver 206. The controller 204 supplies command current to the first control valve 11 to initiate transitions between operational states, including the neutral state 11A0, the lowering state 11A1, the float state 11A2, and the lifting state 11A3. The first driver 205 and the second driver 206 provide current feedback signals that indicate the actual electrical current being supplied to the valves 210, enabling the controller 204 to detect discrepancies between commanded and measured signals.

The controller 204 monitors the current feedback signals to identify fault conditions such as short circuits, open circuits, or component failures that could affect the operation of the first control valve 11. When discrepancies between the command current and the current feedback signals are detected, the controller 204 automatically blocks float activation and initiates predefined safety responses. The fault detection functionality provides closed-loop monitoring that improves reliability and prevents undetected failures that could lead to unsafe operation of the hydraulic system.

The control system 200 supports control state monitoring and logging of operational data for diagnostic, compliance, or operational transparency purposes. The controller 204 records system transitions between operational states of the first control valve 11, including transitions into and out of the float state 11A2. The controller 204 logs the status of the spool locks 211, including engagement and disengagement events, and records manual override events when the electromechanical spool lock 91 is manually disengaged. The controller 204 also monitors and logs float path control states, including the operational status of the blocking valve 113A and other components within the float passages.

A position sensor is disposed within the first control valve 11 and is configured to generate an electrical signal indicative of a position of the control element 80. The electrical signal is transmitted to the controller 204, thereby enabling the controller 204 to determine an operational state of the first control valve 11. The position sensor provides real-time feedback regarding the position of the control element 80 within the first control valve 11, allowing the controller 204 to verify that the first control valve 11 is positioned in the intended operational state and to detect any discrepancies between commanded and actual valve positions.

The controller 204 uses the electrical signal from the position sensor to implement closed-loop control of the first control valve 11, ensuring that the control element 80 is positioned accurately within the neutral state 11A0, the lowering state 11A1, the float state 11A2, or the lifting state 11A3. The position feedback enables the controller 204 to detect mechanical failures, binding, or other conditions that could prevent proper operation of the first control valve 11. The controller 204 integrates the position sensor feedback with the safety logic and fault detection functionality to provide comprehensive monitoring and control of the hydraulic system, ensuring safe and reliable operation across all operational states.

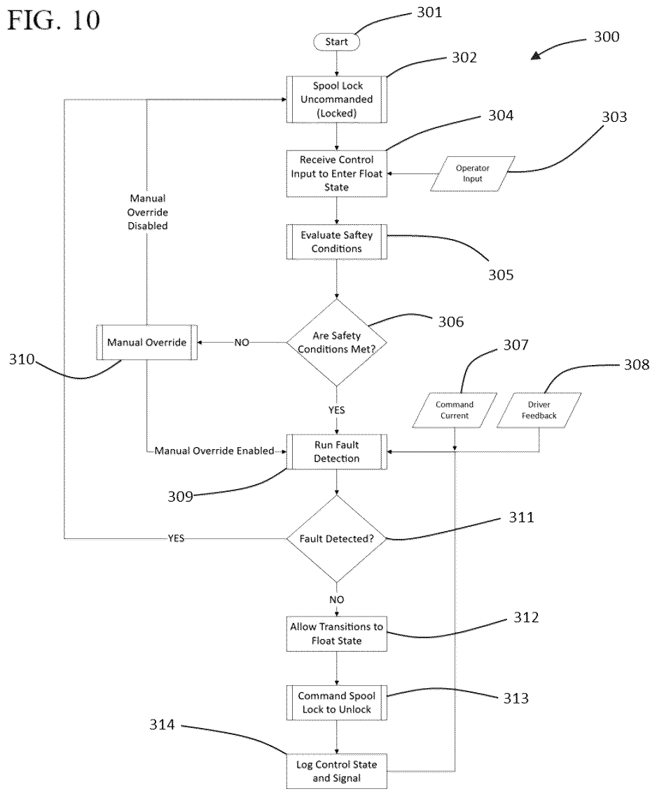

Referring to FIG. 10, a method 300 for controlling float functionality in a hydraulic system is illustrated. The method 300 provides a structured approach to managing transitions of the first control valve 11 into the float state 11A2 while incorporating safety verification, fault detection, and manual override capabilities to prevent unintended actuator movement. The method 300 begins at a step 301, which represents the start of the process and is typically initiated upon powering the machine 150 or the controller 204.

The method 300 proceeds to a step 302, where the electromechanical spool lock 91 is maintained in a locked state by default. The step 302 prevents transition of the first control valve 11 into the float state 11A2 by mechanically restricting movement of the control element 80. The electromechanical spool lock 91 functions as an electronically controlled locking device that remains engaged until specific safety conditions are satisfied, providing mechanical-level protection against unintended float activation.

At a step 303, the method 300 receives operator input through the user interface 203. The step 303 involves receiving a control input to transition the first control valve 11 toward the float state 11A2, which corresponds to operator commands transmitted from input mechanisms such as joysticks, levers, buttons, or other control devices within the cab 124. The operator input is processed by the controller 204 to determine the intended operational state for the first control valve 11.

The method 300 advances to a step 304, where the controller 204 evaluates whether the operator input corresponds to a request to enter the float state 11A2. The step 304 involves analyzing the control input received at the step 303 to determine if the operator is attempting to transition the first control valve 11 into the float state 11A2. The controller 204 compares the received input signals against predetermined thresholds or command patterns that correspond to float state activation.

Concurrently with the step 304, the method 300 implements a step 305 that involves evaluating safety conditions through an independent subprocess. The step 305 includes determining whether one or more safety conditions are satisfied, where the safety conditions comprise at least one of an operator presence signal, a machine orientation condition, a vehicle speed threshold, or a system control logic condition. The step 305 operates continuously to monitor real-time machine and operator conditions that affect the safety of float operation.

The method 300 proceeds to a decision point at a step 306, where the controller 204 determines whether the safety conditions evaluated at the step 305 are satisfied. The step 306 functions as a safety gate that prevents the first control valve 11 from transitioning into the float state 11A2 when the one or more safety conditions are not satisfied. When the safety conditions are not met, the method 300 advances to a step 310, which checks for activation of a manual override mechanism.

The step 310 determines whether a manual override mechanism has been actuated to override the electronically controlled locking device. The manual override mechanism is configured to mechanically disengage the electromechanical spool lock 91 independently of the one or more safety conditions, thereby allowing the first control valve 11 to transition into the float state 11A2 under specific circumstances such as maintenance or fault recovery operations. When no manual override is detected at the step 310, the method 300 returns to the step 302 to maintain the electromechanical spool lock 91 in the locked state.

When a manual override is detected at the step 310, the method 300 proceeds to a step 311 for fault detection as a final safety verification. The step 311 implements the same fault detection routine as described below for the step 309, ensuring that electrical faults are detected even when manual override is activated. When a fault is detected at the step 311, the method 300 returns to the step 302 to retain the locked state and disallow transition to the float state 11A2.

When the safety conditions are satisfied at the step 306, the method 300 advances to a step 309, which involves running fault detection. The fault detection process includes a step 307, where command current is supplied to the first control valve 11, and a step 308, where driver feedback is monitored from the first driver 205 and the second driver 206. The step 307 involves supplying a command current to the first control valve 11 to initiate a transition into the float state 11A2, while the step 308 involves measuring or interpreting a current feedback signal from at least one of the first driver 205 functioning as a high-side driver or the second driver 206 functioning as a low-side driver associated with the first control valve 11.

At the step 309, the controller 204 compares the command current supplied at the step 307 to the current feedback signal monitored at the step 308 to detect a fault condition associated with the attempted transition into the float state 11A2. The step 309 identifies discrepancies between commanded and measured signals that indicate short circuits, open circuits, or component failures within the electrical control system. When a fault is detected at the step 309, the method 300 returns to the step 302 to maintain the locked state and prevent the first control valve 11 from transitioning into the float state 11A2, and the controller 204 initiates one or more safety precautions.

When no fault is detected at the step 309, the method 300 proceeds to a step 312, which allows transitions to the float state 11A2. The step 312 represents the authorization point where the controller 204 permits the first control valve 11 to transition into the float state 11A2 only when the one or more safety conditions are satisfied and no electrical faults are detected. The step 312 enables the transition by allowing the electromechanical spool lock 91 to be disengaged.

The method 300 advances to a step 313, where the controller 204 commands the electromechanical spool lock 91 to unlock. The step 313 involves disengaging the electronically controlled locking device to enable the control element 80 to move into the float state 11A2. The step 313 allows the first control valve 11 to establish fluid communication between the first float connection 41A and the second float connection 41B and the tank 1A via the first float passage 42A and the second float passage 42B, permitting fluid communication between at least one working connection and the tank 1A via a float passage, where the float passage is fluidly connected to at least one float connection and at least one of a primary bypass connection or a float bypass connection, only when the first control valve 11 is in the float state 11A2.

The method 300 concludes with a step 314, where the controller 204 logs the control state and signal data for diagnostic or compliance purposes. The step 314 involves recording or transmitting a control state log associated with the first control valve 11, where the control state log includes at least one of an attempted transition into the float state 11A2, a status of the electronically controlled locking device, an activation of the manual override mechanism, or a state of the blocking valve 113A functioning as an electronically controlled blocking valve. The step 314 provides operational transparency and enables diagnostic analysis of float system operation.

The method 300 further comprises controlling the blocking valve 113A disposed in the third float passage 113, where the blocking valve 113A is configured to prevent fluid communication between the third float passage 113 and the first control valve 11 unless the one or more safety conditions are satisfied. The blocking valve 113A is actuated to permit fluid communication only when the first control valve 11 is in the float state 11A2 and the one or more safety conditions are satisfied, providing hydraulic-level safety protection that operates independently of the mechanical safety mechanisms.

The method 300 provides comprehensive safety management for float functionality by implementing multiple levels of protection including mechanical locking through the electromechanical spool lock 91, hydraulic blocking through the blocking valve 113A, electrical fault detection through current monitoring, and manual override capabilities for maintenance operations. The method 300 ensures that float functionality is available only when the first control valve 11 is intentionally positioned in the float state 11A2 and all safety criteria are satisfied, preventing unintended actuator movement and maintaining safe operation of the hydraulic system across all operational conditions.

The hydraulic system supports alternative actuation methods for the first control valve that provide different approaches to controlling valve positioning while maintaining safety functionality. An electro-hydraulic device is configured to actuate the first control valve using reduced pilot pressure to shift the valve spool into desired positions corresponding to the operational states. The electro-hydraulic device utilizes hydraulic pilot pressure that is lower than the main system pressure to provide controlled movement of the control element within the first control valve. The electro-hydraulic actuation method enables precise positioning of the valve spool while reducing the electrical power requirements compared to direct electronic actuation methods.

The electro-hydraulic device includes pilot control valves that regulate the flow of reduced pilot pressure to actuating chambers within the first control valve. The pilot control valves are electronically controlled and receive command signals from the controller to establish the desired pilot pressure distribution for positioning the control element in the neutral state, the lowering state, the float state, or the lifting state. The electro-hydraulic actuation method provides responsive control of valve positioning while maintaining the ability to generate sufficient force to overcome internal friction and external loads acting on the control element.

A controller and corresponding control algorithm are employed with the electro-hydraulic device to prevent the first control valve from transitioning into the float state unless specific criteria are met. The control algorithm evaluates the same safety conditions described in the previous embodiments, including operator presence signals, machine orientation conditions, vehicle speed thresholds, and control system logic conditions. The controller regulates the pilot pressure supply to the electro-hydraulic device based on the evaluation of these safety criteria, preventing the establishment of pilot pressure conditions that would position the control element in the float state when safety requirements are not satisfied.

The electro-hydraulic actuation method incorporates safety measures through pilot pressure control that operates independently of the mechanical spool lock mechanisms. The controller selectively blocks or redirects pilot pressure flow to the actuating chambers of the first control valve when safety criteria are not met, preventing the control element from moving into the float state even if command signals are present. The pilot pressure control provides hydraulic-level safety protection that complements the mechanical and electronic safety systems described in the previous embodiments.

Pneumatic actuation represents another alternative actuation method for the first control valve, wherein supplied pneumatic pressure is used to position the spool within the valve body. A pneumatic source provides compressed air or other pneumatic fluid to pneumatic actuating chambers within the first control valve. The pneumatic pressure acts on pneumatic pistons or diaphragms that are mechanically coupled to the control element, enabling positioning of the control element among the operational states based on the pneumatic pressure distribution within the actuating chambers.

The pneumatic actuation method utilizes pneumatic control valves that regulate the flow of compressed air to different actuating chambers within the first control valve. The pneumatic control valves are configured to establish specific pressure conditions that correspond to the neutral state, the lowering state, the float state, and the lifting state of the first control valve. The pneumatic actuation method provides reliable operation in environments where electrical systems are subject to interference or where hydraulic pilot pressure is not available.

Safety-critical pneumatic valving is employed to regulate or restrict the pneumatic supply to the first control valve and prevent unintended transitions into the float state. The safety-critical pneumatic valving includes pneumatic safety valves that are configured to block compressed air flow to specific actuating chambers when safety conditions are not satisfied. The pneumatic safety valves are controlled by pneumatic logic circuits or electro-pneumatic control systems that evaluate operator presence, machine orientation, vehicle speed, and other safety criteria before allowing pneumatic pressure to be supplied to the chambers that would position the control element in the float state.

Control algorithms are implemented within pneumatic control systems to provide systematic evaluation of safety criteria and regulation of pneumatic supply to the first control valve. The control algorithms monitor input signals from pneumatic sensors, electrical sensors, or manual control inputs to determine when float state activation is appropriate. The control algorithms generate pneumatic control signals that actuate the safety-critical pneumatic valving, ensuring that compressed air is supplied to the float state actuating chambers only when predefined criteria are satisfied.

The pneumatic actuation method incorporates redundant safety measures through multiple pneumatic safety valves that operate in series to prevent unintended float activation. Primary pneumatic safety valves evaluate operator presence and machine operational status, while secondary pneumatic safety valves assess machine orientation and speed conditions. The pneumatic safety valves are configured such that all safety valves must be in the open position before compressed air reaches the actuating chambers that position the control element in the float state, providing multiple levels of protection against unintended float transitions.

Both the electro-hydraulic and pneumatic actuation methods support manual override capabilities that enable operator-initiated disengagement of safety restrictions under specific circumstances. Manual override valves are provided within the pilot pressure circuits or pneumatic supply circuits to allow direct control of actuating pressure when maintenance operations or fault recovery procedures require manual positioning of the first control valve. The manual override valves are configured with mechanical interlocks or access restrictions that prevent inadvertent activation while allowing authorized personnel to bypass safety systems when appropriate.

The alternative actuation methods integrate with the control system to provide comprehensive monitoring and fault detection capabilities. Position feedback sensors are incorporated within the electro-hydraulic and pneumatic actuation systems to provide real-time indication of control element position and actuating pressure conditions. The control system monitors the position feedback signals and actuating pressures to detect discrepancies between commanded and actual valve positions, enabling identification of mechanical failures, pressure leaks, or other fault conditions that could affect safe operation of the first control valve.

The electro-hydraulic and pneumatic actuation methods support the same float functionality described in the previous embodiments while providing alternative approaches to valve control that are suitable for different operational environments and system requirements. The alternative actuation methods maintain the ability to establish fluid communication between the float connections and the float bypass connections when the first control valve is positioned in the float state, enabling both sides of hydraulic actuators to communicate with tank and allowing free movement in response to external forces. The safety measures incorporated within each actuation method ensure that float functionality is available only when the first control valve is intentionally positioned in the float state and all safety criteria are satisfied, preventing unintended actuator movement and maintaining safe operation across all operational conditions.

The hydraulic system supports alternative configurations for load control valves that provide different approaches to load-holding functionality while maintaining compatibility with float operation through dedicated float passages. These alternative configurations enable the hydraulic system to be adapted for specific operational requirements, pressure conditions, and control strategies while preserving the ability to bypass load-holding restrictions during float operation.

A pilot-operated sequence valve functions as a load control valve that allows flow to occur only once a predetermined pilot pressure is reached, thereby enabling prioritized or staged actuation of hydraulic functions. The pilot-operated sequence valve is disposed within working passages and is configured to remain closed until pilot pressure exceeds a preset threshold value. The pilot-operated sequence valve includes a main valve element that blocks flow through the working passage and a pilot chamber that receives pilot pressure from the hydraulic system. When pilot pressure in the pilot chamber reaches the predetermined threshold, the pilot pressure overcomes a spring force acting on the main valve element, causing the valve to open and permit flow through the working passage.

The pilot-operated sequence valve provides load-holding functionality by maintaining a closed position when system pressure is insufficient to generate the required pilot pressure. The predetermined pilot pressure threshold is selected based on the load characteristics and safety requirements of the hydraulic actuator being controlled. The pilot-operated sequence valve prevents unintended actuator movement when system pressure is low or when the hydraulic pump is not operating, providing safety functionality similar to pilot-operated check valves and counterbalance valve assemblies.

The pilot-operated sequence valve enables prioritized actuation by ensuring that hydraulic functions operate in a predetermined sequence based on pilot pressure availability. Primary functions that generate higher pilot pressures activate before secondary functions that require lower pilot pressures, creating a staged actuation sequence that prevents simultaneous operation of multiple functions when system flow capacity is limited. The pilot-operated sequence valve configuration is particularly beneficial in hydraulic systems where multiple actuators share a common hydraulic supply and operational priority must be established.

Float operation is accommodated through dedicated float passages that are fluidly connected downstream of the pilot-operated sequence valve. The float passages provide alternate flow paths that bypass the pilot-operated sequence valve when the control valve is positioned in the float state. The float passages enable hydraulic fluid to flow from the working passages to tank without passing through the pilot-operated sequence valve, allowing both sides of hydraulic actuators to drain to tank pressure and enabling free movement in response to external forces. The pilot-operated sequence valve remains in its normal load-holding position during float operation while the float passages provide the necessary fluid communication for float functionality.

A single pilot-operated spool valve functions as a load control valve that uses a spool element responsive to pilot pressure to selectively permit or block flow in either direction through working passages. The single pilot-operated spool valve includes a spool element that is positioned within a valve body and is configured to move between different positions based on pilot pressure acting on the spool element. The spool element includes lands and grooves that selectively align with ports within the valve body to establish or block fluid communication paths through the working passage.

The spool element within the single pilot-operated spool valve is responsive to pilot pressure applied to one or more pilot chambers that are fluidly connected to the spool element. When pilot pressure is applied to the pilot chambers, the pilot pressure acts against spring forces or opposing pressures to move the spool element to a position that permits flow through the working passage. When pilot pressure is removed or reduced below a threshold level, spring forces return the spool element to a position that blocks flow through the working passage, providing load-holding functionality.

The single pilot-operated spool valve provides bidirectional flow control by configuring the spool element to selectively permit or block flow in both directions through the working passage based on pilot pressure conditions. The spool element includes multiple lands that can simultaneously control forward flow from the control valve toward the hydraulic actuator and reverse flow from the hydraulic actuator back toward the control valve. The single pilot-operated spool valve enables more complex flow control strategies compared to simple check valve configurations, allowing for controlled flow rates and pressure regulation in both flow directions.

The single pilot-operated spool valve accommodates float operation through dedicated float passages that are positioned to bypass the spool element when the control valve is in the float state. The float passages are fluidly connected to the working passages at locations downstream of the single pilot-operated spool valve, providing alternate flow paths that do not pass through the spool valve. The spool element within the single pilot-operated spool valve maintains its normal load-holding position during float operation, while the float passages enable hydraulic fluid to flow from both sides of hydraulic actuators to tank pressure through the bypass connections.

An electronically controlled valve functions as a load control valve that allows dynamic control of flow characteristics based on electrical signals generated by an operator control unit or machine controller. The electronically controlled valve includes electronic actuators such as solenoids, stepper motors, or servo motors that position valve elements within the valve body in response to electrical command signals. The electronic actuators enable precise control of valve opening, flow rates, and pressure settings based on real-time operational requirements and system conditions.

The electronically controlled valve receives electrical signals from an operator control unit that translates operator inputs into electronic command signals for valve actuation. The operator control unit processes inputs from joysticks, switches, or other operator interface devices and generates corresponding electrical signals that command the electronically controlled valve to specific positions or flow settings. The electronically controlled valve responds to these electrical signals by adjusting internal valve elements to achieve the desired flow characteristics through the working passages.

A machine controller generates electrical signals for the electronically controlled valve based on automated control algorithms, sensor feedback, and predetermined operational parameters. The machine controller monitors system conditions such as pressure, flow rates, actuator positions, and load conditions to determine appropriate valve settings for different operational scenarios. The machine controller generates electrical command signals that optimize valve performance for specific tasks, load conditions, or operational modes, enabling adaptive control of load-holding functionality.

The electronically controlled valve provides dynamic control of flow characteristics by enabling real-time adjustment of valve parameters during operation. Flow rates through the working passages are adjusted by modulating the position of valve elements within the electronically controlled valve based on electrical command signals. Pressure settings are dynamically controlled by adjusting pressure relief settings or flow restrictions within the valve based on changing load conditions or operational requirements. The electronically controlled valve enables the hydraulic system to adapt to varying operational conditions while maintaining appropriate load-holding functionality.

The electronically controlled valve accommodates float operation through coordination with the control valve positioning and dedicated float passages. When the control valve is positioned in the float state, the machine controller or operator control unit generates electrical signals that command the electronically controlled valve to a configuration that permits free flow through the working passages or that becomes inactive to allow flow through the float passages. The electronically controlled valve coordinates with the float passage activation to ensure that load-holding restrictions are appropriately managed during float operation while maintaining safety functionality during normal operational modes.

Each alternative load control valve configuration provides load-holding functionality while accommodating float operation through the dedicated float passages described in previous embodiments. The pilot-operated sequence valve, single pilot-operated spool valve, and electronically controlled valve configurations enable the hydraulic system to be customized for specific applications, operational requirements, and control strategies while preserving the ability to bypass load-holding restrictions when float functionality is activated. The alternative configurations maintain compatibility with the float passage arrangements, bypass connections, and safety systems described in the previous embodiments, ensuring that float operation remains available regardless of the specific load control valve configuration selected for the hydraulic system.

The hydraulic system incorporates additional safety features through valves disposed within float passages that provide secondary protection against unintended float activation and enhanced control over fluid communication between working ports and working passages. A valve disposed within one or more of the float passages is configured to block the passage in a particular state, thereby preventing hydraulic fluid from communicating between the working port and the working passage of the control valve. The valve functions as a secondary safety feature that operates independently of the primary load control valves and provides additional protection against unintended float operation.

The valve disposed within the float passage is positioned between the working passage connection point and the float bypass connection, enabling selective isolation of the float passage from the hydraulic circuit. When the valve is in a closed state, hydraulic fluid is prevented from flowing through the float passage, effectively disabling float functionality even when the control valve is positioned in the float state. The valve blocking capability serves to minimize internal leakage within the hydraulic system by preventing fluid communication through the float passages when float operation is not desired or when system conditions require complete isolation of the working passages.

The valve within the float passage is configured to selectively disable the float function under certain conditions based on operational requirements, safety considerations, or maintenance procedures. The valve responds to control signals that evaluate system conditions such as operator presence, machine orientation, hydraulic pressure levels, or maintenance mode activation. When predetermined conditions indicate that float operation should be disabled, the valve transitions to the closed state to block the float passage, ensuring that the hydraulic actuator operates under controlled pressure conditions rather than float conditions.

The valve disposed within the float passage is actuated through various means including mechanical, hydraulic, pneumatic, or electronic actuation methods. Mechanical actuation utilizes linkages, cams, or manual controls that directly position the valve element within the float passage. Hydraulic actuation employs pilot pressure or system pressure to move valve elements between open and closed positions based on hydraulic control signals. Pneumatic actuation uses compressed air or pneumatic pressure to operate valve elements in response to pneumatic control signals. Electronic actuation incorporates solenoids, stepper motors, or servo motors that position valve elements based on electrical command signals from control systems.

The hydraulic system incorporates valves disposed in both the working passage and the float passage, providing combined benefits of flow control, safety isolation, and functional lockout. The valve configuration within the working passage provides primary load-holding functionality and prevents reverse flow from the hydraulic actuator when system pressure is insufficient to maintain load support. The valve configuration within the float passage provides secondary safety functionality and enables selective isolation of float passages from the hydraulic circuit when float operation is not desired.

The combined valve configuration enables comprehensive flow control throughout the hydraulic system by providing independent control over both normal operational flow through working passages and float flow through float passages. The valve in the working passage regulates flow during normal lifting and lowering operations, while the valve in the float passage controls flow during float operations. The independent control capability enables the hydraulic system to optimize flow characteristics for different operational modes while maintaining appropriate safety restrictions for each mode.

Safety isolation is enhanced through the combined valve configuration by providing multiple points of control over fluid communication within the hydraulic circuit. The valve in the working passage provides primary safety isolation by preventing uncontrolled actuator movement when system pressure is low or when load-holding is required. The valve in the float passage provides secondary safety isolation by preventing unintended float operation when safety conditions are not satisfied or when float functionality should be disabled. The multiple isolation points ensure that hydraulic actuators remain under controlled conditions even when individual valve components experience failures or when system conditions change unexpectedly.

Functional lockout capabilities are provided through the combined valve configuration by enabling complete isolation of hydraulic actuators from both normal operational flow and float flow paths. When both valves are positioned in closed states, the hydraulic actuator is hydraulically locked in position with no fluid communication paths available for movement in either direction. The functional lockout capability is utilized during maintenance operations, transportation, or storage conditions where actuator movement must be prevented regardless of external forces or system pressure conditions.

The hydraulic system supports implementation in parallel circuit configurations as an alternative to series circuit configurations, providing different flow distribution characteristics and operational capabilities. Parallel circuit configurations connect multiple hydraulic functions to a common hydraulic supply such that each function receives hydraulic fluid directly from the pump rather than receiving return flow from upstream functions. The parallel configuration enables simultaneous operation of multiple hydraulic functions without flow interference between functions, providing independent control over each hydraulic actuator.

Parallel circuit implementations utilize flow dividers or priority valves that distribute hydraulic fluid from the pump to multiple control valves simultaneously. Flow dividers split the total pump flow into predetermined proportions that are directed to different control valve sections, ensuring that each hydraulic function receives adequate flow for proper operation. Priority valves establish operational priority among different hydraulic functions by ensuring that primary functions receive full flow before secondary functions receive flow, preventing flow starvation of critical functions during simultaneous operation.

The parallel circuit configuration maintains float functionality through the same float passage arrangements described in previous embodiments while providing different flow distribution characteristics compared to series circuit implementations. Each control valve in the parallel configuration includes float passages that connect working passages to tank through float bypass connections when the control valve is positioned in the float state. The float passages operate independently for each hydraulic function, enabling selective float activation for individual actuators without affecting the operation of other hydraulic functions within the parallel circuit.

Flow control characteristics differ between parallel and series circuit configurations in terms of flow distribution, pressure relationships, and simultaneous operation capabilities. Parallel circuits provide consistent flow rates to each hydraulic function regardless of the operational status of other functions, while series circuits enable flow sharing between functions through return flow utilization. Parallel circuits maintain independent pressure control for each function, while series circuits create pressure relationships between upstream and downstream functions. Parallel circuits support full simultaneous operation of multiple functions limited only by total pump flow capacity, while series circuits enable enhanced flow utilization through return flow sharing but with operational interdependencies between functions.

In another aspect of the disclosure, FIG. 8 provides a side view of a working machine 150 according to embodiments of the present invention. The machine includes a cab 124 configured to house an operator, operator controls, and other key components necessary for machine operation. It should be understood that a cab 124 is not required for a machine to be considered a working machine within the context of the present invention.

A chassis 120 serves as the main structural frame of the machine, supporting the cab 124, tracks 121, hydraulic components, boom 123, and powertrain. The tracks 121 may be implemented in various configurations, such as a wheeled or tracked undercarriage, and are not intended to limit the scope of the present invention.

The chassis 120 includes a pivot point 127, to which the base end of the hydraulic boom cylinder 126 is pinned, allowing the boom cylinder 126 to rotate about the pivot point 127. The chassis 120 also includes a boom pivot point 129, to which the main lift boom 123—commonly referred to as the “boom” and referred to as such hereafter—is pinned, enabling rotation about the boom pivot 129. The rod end of the hydraulic boom cylinder 126 is coupled to the boom 123 at a pivot point 128.

Extension of the hydraulic boom cylinder 126 causes the boom 123 to rotate counterclockwise about the boom pivot 129, an action commonly referred to as lifting the boom. Retraction of the boom cylinder 126 causes the boom 123 to rotate clockwise about the boom pivot 129, generally referred to as lowering the boom.

The boom 123 also includes two additional pivot points. One is the bucket hydraulic cylinder pivot point 131, to which the base end of the hydraulic bucket cylinder 130 is connected. The bucket 125 is attached to the boom 123 at pivot point 133. The rod end of the hydraulic bucket cylinder 130 shares a pivot point 132 with the bucket 125.

When the hydraulic bucket cylinder 130 is extended, the bucket 125 rotates clockwise about its pivot point 133, a motion commonly referred to as dumping the bucket. When the cylinder is retracted, the bucket 125 rotates counterclockwise about the pivot point 133, commonly referred to as curling the bucket.

The hydraulic boom cylinder 126 and hydraulic bucket cylinder 130 each include a base end and a rod end, separated by a piston attached to a rod. Hydraulic fluid is supplied to the base end via a port to extend the cylinder. When the cylinder extends, fluid is expelled from the rod end as return flow. When the cylinder retracts, fluid is supplied to the rod end and expelled from the base end as return flow. This fluid behavior applies symmetrically and is leveraged in various embodiments of the present invention.

In some implementations, the rod end and base end of the boom lift cylinder 126 may be fluidly connected to a low-pressure source or tank, allowing the boom 123 to move vertically in response to ground contour variations as the bucket 125 engages uneven soil 134 during fore-aft movement of the machine. This float functionality enables the bucket to passively follow terrain irregularities, reducing gouging, improving grading consistency during backdragging, and minimizing stress on the boom cylinder and structural components.

Those skilled in the art are familiar with the operating principles of hydraulic cylinders and their applications in a wide range of linkage systems. The foregoing example is provided for illustrative purposes only and is not intended to limit the scope of the invention.

For simplicity, the hydraulic system is described using a single valve in the following examples; however, this is not intended to limit the scope of the invention, as the system may include a plurality of valves fluidly interconnected.

In a first embodiment, as shown in FIG. 1, the valve V1 comprises three separate control valves 11,12,13, each schematically represented by a control element (e.g., a spool), operable by mechanical, hydraulic, pneumatic, or electronic means. The term “control valve” is not intended to be limiting and may refer to a control element, a cavity machined into a valve body, a cartridge valve, a valve section in a sectional valve, or associated connections and passages necessary to achieve hydraulic functionality. A first control valve 11 includes multiple connections fluidly connectable to various internal passages of valve V1.

As used herein, the terms “connection” and “passage” are not limiting. A “connection” may refer to a point of fluid communication that can be selectively blocked or connected to other points. These connection points typically interface with internal passages via machined notches, bores, cast features, or other manufacturing means that form a fluid path. A “passage” may refer to any structure—machined, cast, or otherwise formed—that permits hydraulic fluid to flow between locations.

The first control valve 11 is fluidly connected to the boom base port A1V via a first working passage 50A, which interfaces with a first working connection 40A. Similarly, the boom rod port B1V is fluidly connected via a second working passage 50B to a second working connection 40B. These working connections facilitate bidirectional flow to and from the hydraulic boom cylinder 2A. In this embodiment, pilot-operated check valves 60A and 60B are disposed in-line with the corresponding working passages 50A and 50B, respectively, and are configured to prevent reverse flow from the working passages back to the first control valve 11 unless a sufficient pilot pressure is applied to open the respective check valves.

A first free flow connection 20A is fluidly connected to the pump 10 via supply passage 10A, which in turn connects to a hose, pipe, or other fluid conduit.

A second free flow connection 20B is disposed within the first control valve 11 and is fluidly connected to a first free flow passage 20C. The second free flow connection 20B may comprise multiple internal flow paths that converge into the free flow passage 20C, a configuration commonly referred to as a series connection.

A supply connection 21 is also provided on the first control valve 11 and is fluidly connected to supply passage 10A. First and second bypass connections 30A and 30B are fluidly connected to respective bypass passages 31A and 31B, each connected to tank 1A via one or more return lines such as 1B or 1C.

Optionally, valves 34A and 34B may be disposed within the bypass passages 31A and 31B, respectively. Although these components are not required for the present invention, their presence may enhance performance or allow for additional control strategies in specific configurations.

First and second float connections 41A and 41B are provided within the first control valve 11, fluidly connected to float passages 42A and 42B respectively. Pilot-operated check valves 60A and 60B are disposed within the first and second working passages 50A and 50B respectively.

The float passages 42A and 42B are each fluidly connected downstream of the corresponding pilot-operated check valves 60A and 60B to allow float functionality under defined conditions.

A first float bypass connection 32A and second float bypass connection 32B are disposed within the first control valve 11 and are selectively fluidly connectable to float connections 41A and 41B depending on the valve state. The float bypass connections 32A and 32B are in fluid communication with float bypass passages 33A and 33B, which in turn are fluidly connected to at least one tank passage 1B or 1C, both of which return to tank 1A.

The bypass connections 30A and 30B may be implemented in various forms (single, dual, or multiple configurations) and may optionally include internal valves. These features are not required for the invention to operate but may be beneficial in certain applications.

The first control valve 11 is configured to establish fluidic connections among the aforementioned ports and passages based on its operational state. In certain states, one or more connections may be blocked, which is referred to herein as “closed,” though this term is not intended to be limiting. In other states, multiple simultaneous flow paths may be established to enable targeted control of actuator movement and system behavior.

In a first state 11A0, commonly referred to as the neutral state, the first control valve 11 is in an unactuated position. In this state, the supply connection 21 is typically closed, while a fluidic connection exists between the first free flow connection 20A and the second free flow connection 20B, allowing hydraulic fluid to pass through the valve to downstream components, such as a subsequent control valve or return to tank.

In the first state 11A0, the working connections 40A and 40B may also be fluidly connected to the bypass connections 30A and 30B, respectively, permitting return flow from the actuator to tank 1A via bypass passages 31A and 31B.

Optionally, valves 34A and 34B may be disposed within the bypass passages 31A and 31B, respectively. Although these components are not required for the present invention, their presence may enhance performance or allow for additional control strategies in specific configurations.

In the first state 11A0, the float connections 41A and 41B are fluidly isolated from the remainder of the system, thereby preventing fluid communication between the working passages 50A, 50B, and tank 1A. Likewise, the float bypass connections 32A and 32B are also isolated.

When actuated in a first direction, the first control valve 11 transitions from the neutral state 11A0 to a second state 11A1. In this state, the fluidic connection between the first working connection 40A and the corresponding bypass connection 30A is reduced or eliminated depending on valve displacement. Simultaneously, a fluidic connection is established between the supply connection 21 and working connection 40A, allowing pressurized fluid from pump 10 to be directed to base port A1V and to the actuator port A1A, thereby extending the hydraulic boom cylinder 2A.

Concurrently, the free flow connection between 20A and 20B is restricted or closed, thereby reducing or blocking flow from pump 10 to downstream control elements in the series path.

Unlike conventional control valves, at least one bypass connection remains fluidly connected to a corresponding working connection during state transitions. For example, in state 11A1, the second working connection 40B maintains fluid communication with bypass connection 30B, while a return path may also exist between 40B and free flow connection 20B.

This arrangement allows return flow from the rod port BIA of the hydraulic boom cylinder 2A to simultaneously exit to tank via bypass passage 31B and propagate downstream through free flow passage 20C, allowing for use in downstream control valves.

As in the neutral state, the float connections 41A, 41B, and the float bypass connections 32A, 32B remain fluidly blocked in state 11A1, preventing unintended float activation.

When actuated in the opposite direction, the first control valve 11 transitions from state 11A0 to a third state 11A3, corresponding to boom retraction. In this state, fluidic communication is established between the supply connection 21 and the second working connection 40B, allowing fluid to be delivered to the rod port BIA of the boom cylinder 2A.

The free flow path between 20A and 20B is again restricted or closed to prevent unnecessary downstream flow.

Return fluid from base port A1A of the boom cylinder flows via the first working connection 40A, which maintains a fluid path to bypass connection 30A and optionally to the second free flow connection

This dual-path return strategy enables hydraulic fluid to be returned to tank and reused downstream in series circuit configurations, thereby optimizing system performance.

As in prior states, float connections 41A, 41B, and float bypass connections 32A, 32B remain fluidly isolated from the system in state 11A3, ensuring that float functionality is disabled unless explicitly commanded.

In a fourth state 11A2, the first control valve 11 enters a float state, in which float functionality is enabled as described above. In this state, a fluidic connection 70A is established between float connection 41A and float bypass connection 32A, allowing fluid from working passage 50A to return to tank 1A via bypass passage 33A and a corresponding tank return path such as 1B or 1C.

Similarly, a fluidic connection 70B is established between float connection 41B and float bypass connection 32B, enabling bi-directional drainage from the cylinder to tank and allowing the actuator to float in response to external forces.

The working principles described with respect to the first control valve 11 and its associated passages are not limited to a single valve section. These principles may be replicated across a plurality of control valve sections, such as those illustrated in second control valve 12.

In a second embodiment, as shown in FIG. 2, the functional behavior of states 11A0, 11A1, 11A3, and 11A2 remains substantially the same. However, the configuration of elements between the float connections 41A, 41B and the float bypass connections 32A, 32B differs to support alternative flow control methods.

In states 11A0, 11A1, and 11A3, a check valve 80A is disposed between float connection 41A and float bypass connection 32A and is oriented to prevent flow from the float connection 41A toward the float bypass connection 32A.

The check valve 80A permits reverse flow from the float bypass connection 32A to the float connection 41A when pressure at the float bypass connection exceeds that of the float connection. In like manner, a second check valve is disposed between float connection 41B and float bypass connection 32B, operating under the same principle.

In the float state 11A2, the check valves 80A and 80B are effectively bypassed or rendered inactive, enabling unrestricted fluid communication between float connections 41A, 41B and their respective float bypass connections 32A, 32B.

Additionally, a restriction 71A, 71B may be disposed between the float connections 41A, 41B and their corresponding float bypass connections 32A, 32B to provide damping during float operation. This allows the float response to be tuned based on application requirements.

In a third embodiment, shown in FIG. 3, the valve configuration remains consistent with the prior embodiments, but the pilot-operated check valves 60A, 60B are replaced with counterbalance valve assemblies. Each assembly includes a pilot-operated relief valve 101 or 104 and a corresponding free-flow check valve 100 or 103. Those skilled in the art will recognize the functional behavior of counterbalance valves and their use in load-holding applications.

A fourth embodiment, shown in FIG. 4, also maintains the core valve logic but differs in actuation method. In this configuration, the first control valve 11 is mechanically actuated via a control lever 92 rather than through electronic means.

A detent mechanism 90 may be integrated within the control kit to allow the operator to position the control valve 11 into the float state 11A2 and maintain that position without continued manual input. The detent holds the control valve in the float state until displaced by a deliberate operator action.

An electromechanical spool lock 91 may also be incorporated to restrict movement of the first control valve 11 into certain states. For example, a machined feature on the spool may engage with the spool lock when transitioning from the neutral state 11A0 toward the float state 11A2, thereby preventing unintentional float activation due to accidental lever movement or component failure.

It should be noted that the implementation of an electromechanical spool lock 91 may be used with other control valve positioning devices such as the electronic control described shown in the previous embodiments.

In a fifth embodiment, illustrated in FIG. 5, the float passages 107 and 108 are not directly connected to working passages 50A, 50B. Instead, the float passages are fluidly connected to dedicated float ports 112 and 111, respectively. The working passages 50A and 50B are fluidly connected to working ports 109 and 110, which interface with a flangeable manifold 99.

The flangeable manifold 99 includes corresponding float passages 113, 114, each fluidly connected downstream of respective pilot-operated check valves 115, 116. This configuration simplifies the machining and integration of load-holding components by relocating them from the valve body to the manifold.

In a sixth embodiment, shown in FIG. 6, restrictions 117 and 118 are disposed within the float passages 113 and 114, respectively. These restrictions function to dampen float behavior in the same manner as described in earlier embodiments.

In a seventh embodiment, shown in FIG. 7, an electronically controlled blocking valve 113A is disposed in at least one of the float passages 113 within the flanged manifold 99.

This valve may be used to block flow from working port A1V to tank in the event that the control valve 11 enters the float state 11A2 unintentionally. The blocking valve 113A may be replaced with a proportional valve, hydraulically piloted valve, or manually operated valve, and is not limited to the schematic form illustrated. When predetermined safety criteria are met the blocking valve 113A may transition from the blocked state to open state allowing for unrestricted float functionality.

FIG. 9 illustrates an embodiment of a control system 200 configured to control the operation of hydraulic valve V1 and control valves 11, 12, 13, as well as other components of the machine 150. The control system may also operate auxiliary components such as spool locks 91, blocking valves 113A, or electronically actuated alternatives to the pilot-operated load-holding valves 60A, 60B, or 101, 104.

The control system 200 includes a controller 204 having a plurality of inputs and outputs for receiving sensor data and transmitting commands. Communication between the controller and system components may occur via a CAN bus, direct wiring, or wireless protocols such as Bluetooth, Wi-Fi, or other radio transceivers.

The controller 204 may also communicate with external devices via a communication module 202 linked to a network 201. The network 201 may include, for example, GPS, a cellular network (e.g., 5G), or a wide area network (WAN).

A user interface 203 is provided to receive operator input and transmit it to the controller 204. The interface may include joysticks, levers, foot pedals, buttons, switches, touchscreens, or other mechanisms. In cab 124, the input mechanisms are located near the operator station, but may also be implemented in open-station designs.

Operator input to control a function such as boom movement is received by the user interface 203 and translated into a command current by the controller 204, which then actuates the appropriate valve or set of valves 210 to initiate a state change (e.g., into lift, lower, or float modes). For joystick-based systems, the command current may be proportional to the displacement angle of the joystick.

The control system 200 may also include a sensor suite 207 comprising various sensors, including but not limited to pressure sensors 208,209, operator presence sensors, rotary position sensors, linear position sensors, spool position sensors, and inertial measurement units (IMUs). These sensors provide feedback to the controller 204 to inform safety and control decisions.

A key feature of the control system is the integration of spool locks 91, 211 to mechanically restrict movement of valves 11, 12, or 13. The controller 204 may command these locks to engage or disengage based on operating conditions, safety states, or user input. In most configurations, the spool lock is spring-loaded to the locked position and requires a command signal to disengage.

The spool lock 91 may be configured specifically to prevent transition into the float state 11A2, protecting against unintentional motion caused by accidental operator input or electrical faults (e.g., a short circuit causing unintended valve actuation).

FIG. 10 illustrates a flow diagram of a first set of instructions 300 implemented within a float prevention module executed by the controller 204. Upon powering the machine or controller, the instruction sequence is initiated at step 301. Initially, the spool locks are held in a locked position by default (302), preventing transition of the first control valve 11 into the float state 11A2.

When an operator input is received (303), the controller evaluates whether the input corresponds to a request to enter the float state (304). Simultaneously, safety conditions 305 are assessed through an independent subprocess.

If the safety conditions are satisfied (306), the procedure advances to a fault detection step 309, where the system verifies that no electrical faults exist. This includes comparing the command current supplied to the valve (307) with current feedback from a high-side or low-side driver (308) to detect mismatches that may indicate a short, open, or failure condition.

If no fault is detected, the procedure advances to a transition step 312, in which the controller authorizes the spool lock to disengage (313), allowing the control valve 11 to enter the float state 11A2. The control system also records the control state and signal data (314) for diagnostic or compliance purposes. The fault detection procedure may be repeated continuously while the valve remains in a commanded or uncommanded state.

If the safety conditions are not satisfied in step 306, the system checks for activation of a manual override (310). If no manual override is present, the controller maintains the spool lock in the locked state (302). If a manual override is detected, the system advances to the fault detection routine (311) as a final safety verification.

If a fault is detected in step 311, the system retains the locked state by default and disallows transition to float. The control logic may remain in this protective mode until the fault is cleared or additional supervisory conditions are satisfied. This safety logic may be repeated in a continuous loop or supplemented by other system-level fault routines. These behaviors are illustrative and are not intended to limit the scope of the present invention.

The additional system features including valves within float passages, combined valve configurations in working and float passages, and parallel circuit implementations enhance system safety by providing multiple levels of control over hydraulic fluid communication and actuator movement. The features enhance control capabilities by enabling independent regulation of normal operational flow and float flow through separate valve elements. The features enhance operational flexibility by supporting different circuit configurations that accommodate varying operational requirements, flow distribution needs, and control strategies while maintaining float functionality and safety protection across all configurations.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A hydraulic system for a machine, comprising:
a tank operable to store a hydraulic fluid;
a first pump operable to output a flow of hydraulic fluid;
a first hydraulic actuator having a first fluid port and a second fluid port;
a first control valve controllable among a plurality of states including a neutral state, a lowering state, a float state, and a lifting state to control the first hydraulic actuator, the first control valve comprising:
a first free flow connection fluidly connectable to a second free flow connection;
a supply connection configured to receive pressurized fluid from the first pump;
a first working connection and a second working connection, each fluidly connected to a respective first fluid port and second fluid port via a corresponding first working passage and second working passage;
a first float connection fluidly connected to a first float passage;
a second float connection fluidly connected to a second float passage;
a first float bypass connection fluidly connected to a first float bypass passage; and
a second float bypass connection fluidly connected to a second float bypass passage;
a first load control valve disposed in-line with the first working passage;
wherein the first float passage is fluidly connected to the first working passage downstream of the first load control valve;
wherein the second float passage is fluidly connected to the second working passage; and
wherein in the float state, the first float connection is fluidly connected to the first float bypass connection and the second float connection is fluidly connected to the second float bypass connection, thereby permitting flow from both the first fluid port and the second fluid port to the tank via the first float passage and the second float passage.

2. The hydraulic system of claim 1,
wherein a second load control valve is disposed in-line with the second working passage; and
wherein the second float passage is fluidly connected to the second working passage downstream of the second load control valve;

3. The hydraulic system of claim 1, wherein the first load control valve comprises at least one of a pilot operated check valve, a pilot operated relief valve, a sequence valve, or a pilot operated counterbalance valve, and being configured to prevent fluid flow from the first working port to the first fluid port when the first control valve is in the first neutral state but allow fluid flow between the first working port and the first fluid port when the first control valve is transitioned to the lowering or lifting state.

4. The hydraulic system of claim 2, wherein the second load control valve comprises at least one of a pilot operated check valve, a pilot operated relief valve, a sequence valve, or a pilot operated counterbalance valve, and being configured to prevent fluid flow from the second working port to the second fluid port when the first control valve is in the first neutral state but allow fluid flow between the second working port and the second fluid port when the first control valve is transitioned to the lowering or lifting state.

5. The hydraulic system of claim 1, further comprising a first check valve disposed between the first float connection and the first float bypass connection; and is configured to prevent fluid flow from the first float connection to the first float bypass connection when the first control valve is not in the float state.

6. The hydraulic system of claim 5, further comprising a second check valve disposed between the second float connection and the second float bypass connection; and is configured to prevent fluid flow from the second float connection to the second float bypass connection when the first control valve is not in the float state.

7. The hydraulic system of claim 1, further comprising a first restriction disposed in the first float passage.

8. The hydraulic system of claim 7, further comprising a second restriction disposed in the second float passage.

9. The hydraulic system of claim 1, further comprising an electronically controlled locking device configured to mechanically prevent the first control valve from transitioning into the float state unless predetermined safety conditions are satisfied.

10. A method for controlling float functionality in a hydraulic system comprising a first control valve operable in a plurality of states including a float state, the method comprising:
receiving a control input to transition the first control valve toward the float state;
determining whether one or more safety conditions are satisfied, the safety conditions comprising at least one of an operator presence signal, a machine orientation condition, a vehicle speed threshold, or a system control logic condition;
preventing the first control valve from transitioning into the float state when the one or more safety conditions are not satisfied, by engaging an electronically controlled locking device configured to mechanically restrict movement of a control element;
allowing the first control valve to transition into the float state only when the one or more safety conditions are satisfied; and
permitting fluid communication between at least one working connection and a tank via a float passage, the float passage being fluidly connected to at least one float connection and at least one float bypass connection, only when the first control valve is in the float state.

11. The method of claim 10, further comprising overriding the electronically controlled locking device by actuating a manual override mechanism configured to mechanically disengage the locking device independently of the one or more safety conditions.

12. The method of claim 10, further comprising controlling an electronically controlled blocking valve disposed in the float passage, wherein the blocking valve is configured to prevent fluid communication between the float passage and the first control valve unless the one or more safety conditions are satisfied.

13. The method of claim 12, wherein the electronically controlled blocking valve is actuated to permit fluid communication only when the first control valve is in the float state and the one or more safety conditions are satisfied.

14. The method of claim 10, further comprising:
supplying a command current to the first control valve to initiate a transition into the float state;
measuring a current feedback signal from at least one of a high-side driver or a low-side driver associated with the first control valve;
comparing the command current to the current feedback signal to detect a fault condition associated with the attempted transition into the float state; and
in response to detecting the fault condition, preventing the first control valve from transitioning into the float state and initiating one or more safety precautions.

15. A hydraulic valve assembly, comprising:
a first control valve having a control element operable among a plurality of states including a float state;
a first working connection and a second working connection disposed within the first control valve;
a first float connection and a second float connection disposed within the first control valve;
a first float bypass connection and a second float bypass connection disposed within the first control valve; and
a flanged manifold fluidly connected to the first control valve, the flanged manifold comprising:
a first manifold working port fluidly connected to the first working connection;
a second manifold working port fluidly connected to the second working connection;
a first manifold float port fluidly connected to the first float connection;
a second manifold float port fluidly connected to the second float connection;
a first load holding valve disposed within the flanged manifold between the first manifold working port and the first working connection;
a third float passage fluidly connected to the first manifold float port and positioned downstream of the first load holding valve; and
a fourth float passage fluidly connected to the second manifold float port;
wherein in the float state, the first float connection is fluidly connected to the first float bypass connection and the second float connection is fluidly connected to the second float bypass connection, thereby enabling fluid communication from the third float passage and the fourth float passage to a tank.

16. The hydraulic valve assembly of claim 15, further comprising a second load holding valve disposed within the flanged manifold between the second manifold working port and the second working connection;
wherein the fourth float passage is fluidly connected to the second manifold float port and positioned downstream of the second pilot-operated check valve;

17. The hydraulic valve assembly of claim 15, further comprising a first restriction disposed in the third float passage.

18. The hydraulic valve assembly of claim 17, further comprising a second restriction disposed in the fourth float passage.

19. The hydraulic valve assembly of claim 15, further comprising an electronically controlled blocking valve disposed in the third float passage, wherein the blocking valve is configured to selectively block or permit fluid flow based on predetermined safety conditions.

20. The hydraulic valve assembly of claim 19, further comprising an electronically controlled blocking valve disposed in the fourth float passage, wherein the blocking valve is configured to selectively block or permit fluid flow based on predetermined safety conditions.
